(19) United States
(12) Patent Application Publication
(10) Pub. No.: US 2003/0081624 A1
(43) Pub. Date: May 1, 2003

(54) Methods and apparatus for packet routing with improved traffic management and scheduling

(76) Inventors: Vijay Aggarwal, Marlboro, MA (US); Wayne Boland, Acton, MA (US); Brittain McKinley, Groton, MA (US); Alan Beardsley, Bedford, MA (US); John Flanders, Ashland, MA (US)

Correspondence Address: David J. Powsner, Nutter, McClennen & Fish, LLP, One International Place, Boston, MA, 02110-2699, US

(21) Appl. No.: 10/281,340

(22) Filed: Oct. 24, 2002

Related U.S. Application Data
(63) Continuation of application No. 10/087,006, filed on Feb. 28, 2002.
(60) Provisional application No. 60/272,407, filed on Feb. 28, 2001.
(60) Provisional application No. 60/272,387, filed on Feb. 28, 2001.
(60) Provisional application No. 60/272,328, filed on Feb. 28, 2001.

(51) Int. Cl. H04L 12/28; H04L 12/56

(52) U.S. Cl. 370/412

(57) ABSTRACT

The present invention provides systems for improved quality of service and traffic management in network routers and other devices. This is achieved, according to one aspect of the invention, by coupling a plurality of queue processors to a plurality of input interfaces that receive data from one or more respective network connections. Each queue processor, in coordination with an associated scheduler that schedules dequeing of data from one or more queues, maintains the quality of service levels with respect to throughput, and delivers the data for a particular output context based on priority to a respective output interface. The output interface is coupled to the plurality of queue processors and transfers the data to one or more respective network connections. In addition, a plurality of output interfaces can be coupled to respective pluralities of queue processors for transferring data therefrom to one or more destination network connections. Packets, cell, datagrams and so forth passing through the router are disassembled and marked with one or more priority levels. Prior to exiting the router they re reassembled (based on those priorities, inter alia) into their constituent forms for continued routing on the network.

### REFERENCE TO RELATED APPLICATIONS

This application claims the benefit of priority of the following United States provisional patent applications, the teachings of which are incorporated herein by reference: IMPROVED QUALITY OF SERVICE; Serial No. 60/272,407; Filing Date: Feb. 28, 2001; METHODS AND APPARATUS FOR PACKET ROUTING WITH IMPROVED TRAFFIC MANAGEMENT AND SCHEDULING; Serial No. 60/272,387; Filing Date: Feb. 28, 2001; IMPROVED PACKET REASSEMBLY; Serial No. 60/272,328; Filing Date: Feb. 28, 2001.

### BACKGROUND OF THE INVENTION

The invention pertains to computer and communication networks, and particularly, to improving quality of service and traffic management within such networks. More particularly, the invention relates to apparatus for efficiently forwarding data from one or more source ports to one or more destination ports of a networking device. The invention has application in network routers, switches and other traffic-bearing nodes.

Rapid advances in technology and network growth have resulted in more capacity in the core network (the backbone network operated and maintained by carriers). Increased broadband implementation is providing wider service capabilities in the access network (the DSL, cable and other networks that provide interfaces to end user equipment). However, the edge network (the interface between the core and access networks that is operated and maintained by Internet Service Providers), is lagging behind, thereby, leaving untapped capacity in the core and access networks.

To date, carriers, e.g., AT&T, Sprint, have been inefficient in accessing all the additional bandwidth that is available as a result of these new developments. Service providers, e.g., America On-line, Earthlink, MSN, have been forced to use a complex patchwork of solutions, e.g., multiple routers, network devices, which are not well integrated and result in overlapping layers of functionality and capability. Inevitably, service providers must continuously update, modify and better integrate their network architectures, which increases overall costs and inefficiency.

Current network switch architectures that are utilized in edge networks are costly, and are comprised of complex centralized switch fabrics and central processing units. These switch architectures are not readily scalable, and are plagued by switching conflict delays, e.g., blocking problems. The costly switching conflict delays make it difficult for service providers to guarantee the performance they have contracted to deliver under their existing service level agreements, and to deliver that performance with guaranteed quality of service.

In multi-layered edge networks, the costs, inefficiencies, and complexities further increase, because the aggregation, provisioning, switching and routing functions are not typically consolidated into a single network device. This results in the inclusion of multiple layers of unnecessary routers.

An object of this invention is to provide improved methods and apparatus for computer and communication networks. A related object is to provide such methods and apparatus as provide improved quality of service and traffic management within such networks.

A further object is to provide methods and apparatus for computer and communications networks that eliminate or reduce switching conflict delays, and that support multiple services simultaneously, i.e., any protocol on any interface port in a network device.

Another object of this invention is to provide such methods and apparatus as facilitate consolidation of the aggregation, provisioning, switching and routing functions into fewer or a single network device.

A still further object is to provide such methods and apparatus as provide performance improvements over the prior art.

Another object of this invention is to provide a highly scalable and cost-efficient architecture for network routing.

### SUMMARY OF THE INVENTION

Traffic Management

The aforementioned objects are attained by the invention, which provides methods and apparatus for improved traffic management in network devices, e.g., routers, switches and other traffic bearing nodes (collectively, “network devices”). This is achieved, according to one aspect of the invention, by storing data received from each of a plurality of network connections to queues (or sets of queues) based on the communication contexts (e.g., output network connection) to which those data belong. Processor logic (referred to below as a “queue processor”) associated with respective sets of the queues operates in conjunction with scheduling logic associated with all of the queues to dequeue the data for output, via the same or additional network connections.

Related aspects of the invention provide devices as described above in which incoming data is stored to the queues based on priority as well as context. Thus, for example, data pertaining to, say, four priority levels for a given context can be stored to each of four queues associated with that context. Therefore, in a system having 512 output contexts, each queue processor would be associated with 2048 queues (512 contexts times 4 priority queues).

Further aspects of the invention provide network devices as described above in which multiple queue processors and their associated sets of queues are coupled to respective input interfaces, each of which receives data from one or more associated network connections. The input interfaces can, according to related aspects of the invention, disassemble, or de-format packets or other units of data received from the associated network connections, placing that data in a form suited for storage in the queues and manipulation by the queue processors. The queue processors (and their associated queues) are likewise coupled to an output interface that transfers data to one or more associated network connections. The output interfaces can, conversely, reformat and/or reassemble data into a format suited for output on the respective network connections.

For example, a network router, switch, or other device according to the foregoing aspects of the invention can have a plurality of input interfaces, each receiving data from one or more network connections. A set of queues and an associated queue processor are coupled to each respective input interface. The plurality of queue processors (and associated queues) are also coupled to a single output interface, which can include a packet reassembly unit and network interface processor that, itself, drives data to one or more network connections.

Continuing with the counts from example above, incoming data received by the input interfaces is stored to one of the four priority queues associated with the specific output context (of the 512 output contexts associated with the particular output interface) to which that packet belongs. Each queue processor, with the assistance of the scheduling logic, dequeues the data for a particular context by priority and delivers it to the output interface, which, in turn, transfers the data to its intended destination network connections, e.g., LANs, MANs, WANs.

Further aspects of the invention provide network devices as described above, which include multiple sets of queue processors, each set having a plurality of queue processors (each of with associated queues and common scheduling logic). As above, each set coupled to a respective plurality of input interfaces and to a single respective output interface. The multiple sets of queue processors of this aspect of the invention, accordingly, drive multiple output interfaces.

Continuing the example above, a network router, switch, or other device according to this aspect of the invention can have, say, sixteen input interfaces each of which receives (and depacketizes) data from one or more network connections. The device can likewise have, say, sixteen output interfaces each of which (packetizes and) drives data to those same or different network connections. Data received by the input interfaces is stored to the queues whose set (i.e., queue processors, queues and output interface) are associated with the network connections over which that data must be output. As above, the data is stored to the queues in accord with context and priority. And, as above, each queue processor, with the assistance of the scheduling logic, dequeues the data for a particular context by priority and delivers it to the output interface, which, in turn, transfers the data to its intended destination network connections, e.g., LANs, MANs, WANs. An advantage of this configuration is that large quantities of input data are funneled to their respective destination network connections with increased efficiency and maximized throughput.

Further aspects of the invention provide systems as described above, in which received data is stored to the queues in linked-list form. Each queue processor dequeues the data from a selected queue by following those lists, and transmits the data to the output interface for transfer to the appropriate network connections. The queue processors can, according to further aspects of the invention, discard data, and maintain a list of statistics and parameters in memory.

Quality of Service

Further aspects of the invention provide methods and apparatus for improved quality of service in network devices, e.g., routers, switches and other traffic bearing nodes (collectively, “network devices”). This is achieved, according to one aspect of the invention, by storing data received from each of a plurality of network connections to queues (or sets of queues) based on the communication contexts (e.g., output network connection) to which those data belong. Processor logic (referred to below as a “queue processor”) associated with respective sets of the queues operates in conjunction with scheduling logic associated with all of the queues to dequeue the data for output, via the same or additional network connections, in a manner that achieves quality of service requirements.

A scheduler that is coupled to a plurality of queues and associated processor logic (queue processors) schedule dequeing of data from one or more queues for transfer to an output interface to meet quality of service requirements. The scheduler interfaces with the queue processors to identify contexts requiring service and to identify a particular priority queue from which data is to be dequeued to an output network connection.

In a related aspect, the invention provides a scheduling table with entries that correspond to time slots, say, of 130 ns, in a “frame.” Each entry identifies a context that is to be serviced in the respective time slot and can also provide control flags, such as an aggregation mask and a master flag. The scheduler reads one table entry per slot to determine for which context a packet is to be dequeued. This is repeated each frame. The scheduling table is preset or dynamically programmed to service the queues (and underlying contexts) to reflect quality of service requirements.

According to further aspects of the invention, in each time slot, a scheduler as described above polls the queue processor to determine whether their respective queues have pending packets for the context to be serviced during that time slot. The queue processors whose queues hold data for a corresponding network connection can respond to the scheduler by indicating the priority level of that data and, according to related aspects of the invention, whether the corresponding queues are “starved,” i.e., not been serviced within a certain time threshold.

In still further aspects, the invention provides a scheduler as described above, which selects a specific queue processor and corresponding queue based on queue priority and on starved status. Typically, priority queues for any given context are serviced first, with the queue processors being handled on a round-robin basis.

In another aspect, the invention provides a router, switch, or other network device as described above that has a control flag, such as a “starved bit,” or other indicator associated with one or more queues to indicate whether the associated queue has been dequeued within a certain time threshold. A scheduler can respond to such an indicator by scheduling the dequeing of the starved queues before all other queues. In embodiments where dequeuing is normally determined by priority, this essentially results in starved queues receiving higher effective priority than non-starved queues regardless of their initial priority level.

By way of non-limiting example, a system operating in accord with this aspect of the invention could initially set the starve indicator to a numerical threshold value, such as zero that is decremented each time the scheduler does not select a corresponding queue for dequeuing. When the corresponding queue is finally dequeued, the starve indicator is incremented into the positive range by a specified amount, e.g., +10.

In another aspect, the invention provides a router, switch, or other network device as described above that has an aggregation mask, or other indicator that is associated with one or more queues, to indicate that dequeing of data is only permitted from starved queues. The scheduler responds to the aggregation mask by scheduling dequeuing of associated starved queues. The advantages of this configuration include, preventing unwanted bursting, e.g., for ATM-CBR (Asynchronous Transfer Mode-Constant Bit Rate).

In another aspect, the invention provides a router, switch, or other network device as described above that has a master flag, or other indicator associated with one or more queues to ensure that the responses to the scheduler from the queue processors are taken from only one queue processor, which serves as a collecting point for responses from all queue processors whose associated queues are starved. This advantage ensures that all queues get a chance to notify that they are starved.

Packet Disassembly, Routing and Reassembly

Still further aspects of then invention provide methods and apparatus for improved packet reassembly in network devices, e.g., routers, switches and other traffic bearing nodes. Such network devices, according to one aspect of the invention, utilize an input section that receives packets (e.g., cells, frames, datagrams) from one or more network connections and that fragments the packets into one or more respective portions or units. A routing mechanism, e.g., a fully meshed switch fabric, transfers the units from the input section to an output section, whence they are routed back to the network. The output section receives the units intermingled with one another. A reassembly unit reassembles the intermingled units into respective packets on the basis of at least a context associated with the network connection to which those respective packets will be output.

According to related aspects of the invention, the input section can associate each received packet with an ingress priority and can transfer the units to the routing mechanism intermingled, if at all, on the basis of that priority. The input section can also utilize the packet classification to associate each corresponding packet with an identifier, which is used to determine further parameters for routing through the network device. These include an egress priority and a context, among others. Packets transferred from the routing mechanism to the output section may be intermingled on the basis of those additional parameters (i.e., egress priority and context), as well as on the basis of ingress priority. They may be further intermingled on the basis of a slot identifiers associated with cards that make up the routing mechanism. According to related aspects of the invention, the reassembly unit reassembles the intermingled units into their respective packets based on all of these parameters, i.e., context, slot number, ingress priority, and egress priority.

Still further aspects of the invention provide devices as described above in which the output section checks units received from the routing mechanism for errors (e.g., missing unit errors, timeout errors, and so forth) discarding packets and/or units that have errors while forwarding to the network connection those packets that do not have errors.

Related aspects of the invention provide devices as described above in which the input interface includes an aggregation module that associates each received packet with a priority and an identifier, breaks each packet into one or more respective fragments, and forwards each fragment to a standardizer module. The standardizer module, according to still further related aspects, can utilize the identifier to determine the aforementioned parameters, e.g., from a configuration table. It can reassemble the received fragments into one or more units for transfer to the routing mechanism intermingled on the basis of priority. Each unit can, according to aspects of the invention, have a header that includes the corresponding parameters. The routing mechanism as described above can, according to further related aspects of the invention, store the received units into one or more queues that correspond to egress priority and transmit the units based on that priority to the output interface.

Further aspects of the invention provide network devices as described above in which the routing mechanism includes queues and queue processors as described above.

The output interface, according to still further aspects of the invention, can include a reassembly processing unit and a routing switch processor. The reassembly unit can reassemble the units into one or more respective packets and segment the packets into units that are forwarded based on priority to the routing switch processor. The routing switch processor converts the units into their original packet format and transfers the packets to the corresponding network connection based on priority and context.

Further aspects of the invention provide systems as described above, in which one or more output interfaces each comprise a reassembly processing unit and a routing switch processor. The output interfaces receive intermingled units from different respective packets, and utilize the reassembly unit to reassemble the units into their respective packets based on context, ingress priority, egress priority, and slot number. The reassembly unit then transfers the packets to the routing switch processor, which transfers the packets to corresponding network connections based on egress priority.

Further aspects of the invention provide methods paralleling the operations described above. These and other aspects of the invention are evident in the drawings, description, and claims that follow.

### BRIEF DESCRIPTION OF THE DRAWINGS

A more complete understanding of the invention may be attained by reference to the drawings, in which:

FIG. 1 depicts the architecture of a network router that utilizes an improved quality of service and traffic management system according to the invention;

FIG. 2 depicts the internal architecture of an input interface in a network router according to the invention;

FIG. 3 depicts the runtime representation of the operation of a system according to the invention;

FIG. 4 is a block diagram of a fast pattern processor that can be implemented as a component of an input interface in a system according to the invention;

FIG. 5 is a functional processing diagram of the fast pattern processor of FIG. 4;

FIG. 6 depicts the reassembly of AAL5 streams using the fast pattern processor of FIG. 4;

FIG. 7 depicts how the fast pattern processor of FIG. 4 provides Level 2 ATM cell switching;

FIG. 8 is a block diagram of a flow management unit in a system according to the invention;

FIG. 9 is a block diagram of an ingress buffer in a system according to the invention;

FIG. 10 is a block diagram of a quality of service subsystem in a system according to the invention;

FIG. 11 depicts the handshake protocol between components and the interface that performs switching in a network router according to the invention;

FIG. 12 depicts the format of data in a scheduling table and the decoding of egress requests according to the invention;

FIG. 13 is a block diagram of an egress multiplexer in the output interface in a system according to the invention;

FIG. 14 is a block diagram of a reassembly processing unit in the output interface of a system according to the invention;

FIG. 15 is a block diagram of a routing switch processor and its associated memories and interfaces in the output interface of a network router according to the invention;

FIGS. 16A-16D depict packet disassembly, routing and reassembly in a network device according to the invention; and

FIGS. 17A-17D depict how packets and fragments thereof are interleaved during disassembly, routing and reassembly by a network device according to the invention.

### DETAILED DESCRIPTION OF THE ILLUSTRATED EMBODIMENT

The present invention provides systems for improved quality of service and traffic management in network routing devices. It has application in efficiently moving data from a source port, e.g., on ATM, Frame Relay, Ethernet, or other such networks, to one or more destination ports on these or other networks.

By way of overview, the illustrated embodiment comprises a board that is a common processing platform for all I/O types supported within a node. An on-board host micro-processing unit provides CPU, memory, local non-volatile storage, and I/O to the rest of the board. The board connects the link-specific I/O cards e.g., SONET, ATM, Frame Relay, Ethernet, to and from a mid-plane using custom logic based on a cell flow similar to ATM. Each flow received from the I/O cards is classified and converted into a series of link-independent proprietary cells which are directed to other boards in the system via a mid-plane high speed cross-connect. Cells received from other boards via the mid-plane are priority enqueued and then scheduled for egress, merged, reassembled, and shaped for transmission to the I/O cards.

The end-to-end process yields a highly-configurable, line-rate, level 2-3 switch for any-to-any connection of ATM, Frame Relay, Packet-Over-SONET, 10/100/1000 Ethernet, and TDM CES with precise bandwidth control and low latency and jitter on each flow.

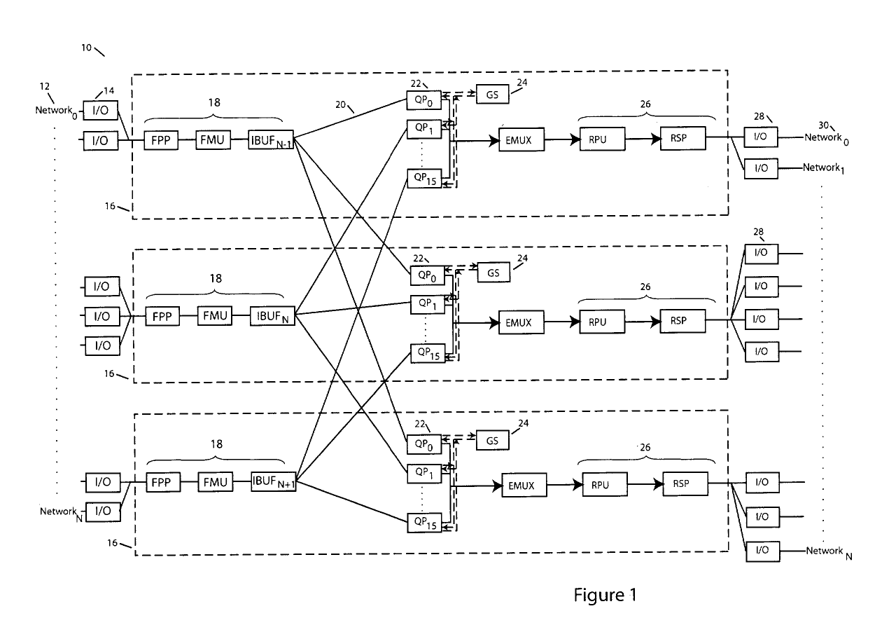

FIG. 1 illustrates a network device (or node) 10 in which the invention can be implemented. A plurality of I/O devices 14 (e.g., conventional network interface cards, adapters and/or circuitry) receive data from a plurality of networks 12, e.g., LANs, MANs, WANs, or other networks (regardless of whether implemented in SONET, ATM, Frame Relay, Ethernet, and so forth), and deliver the data to a plurality of cards 16 constructed in accord with the teachings below that route the data to plurality of networks 30 via I/O devices 28 (e.g., again conventional network interface cards, adapters and/or circuitry). Networks 30 may of the same or different variety as networks 12 and may constitute portions of the same network, in whole or in part. Those skilled in the art will appreciate that the use or number of cards is merely an illustration of one implementation and not a limitation of the invention.

With continued reference to FIG. 1, each card 16 contains an input interface 18, a plurality of queue processors 22 interconnected with the input interfaces 18 via a mid-plane cross-connect fabric 20, a scheduler 24 that is associated with respective pluralities of queue processors, and an output interface 26 that transfers data to one or more respective network connections 30, via destination I/O devices 28.

In the illustrated embodiment, a mid-plane cross-connect 20 couples each input interface 18 to a single queue processor 22 on every card 16 in the system. Incoming data, e.g., packets, datagrams, cells, and so forth, received via I/O devices 14 are converted into a common format, e.g., augmented ATM cells (referred to below as “GCells”) by the input interface 18. Each cell is transferred over the mid-plane cross-connect 20 to the card 16 and, particularly, the queue on that card corresponding to the output I/O device 28 and network 30 for which the packet is destined (e.g., as determined in the conventional manner from addressing contained in the incoming data and from routing tables (not shown) pertaining thereto).

As shown in the drawing, each card has a single input interface 18 and a plurality of queue processors 22. In the illustrated embodiment only one queue processor is connected to that card's input interface. The remaining queue processors 22 are connected to the input interfaces 18 on other cards 16. This configuration forms a cross-connect “mesh” that allows for flexible internal routing without congestion.

Each queue processor 22 is associated with a plurality of queues in which the received data, from a respective input interface 18, is stored according to context and priority. Each plurality of queue processors 22 interfaces with an associated scheduler 24 to dequeue and send received data (whether from local input interface 18 or one located on another card 16) to a local output interface 26. The data is selected and dequeued on a round robin basis in view of a particular context, priority, quality of service requirements, and destination throughput all as reflected by parameters evaluated by the scheduler 24. The respective output interface 26 then transfers the data to one or more respective network connections 30, via destination I/O devices 28.

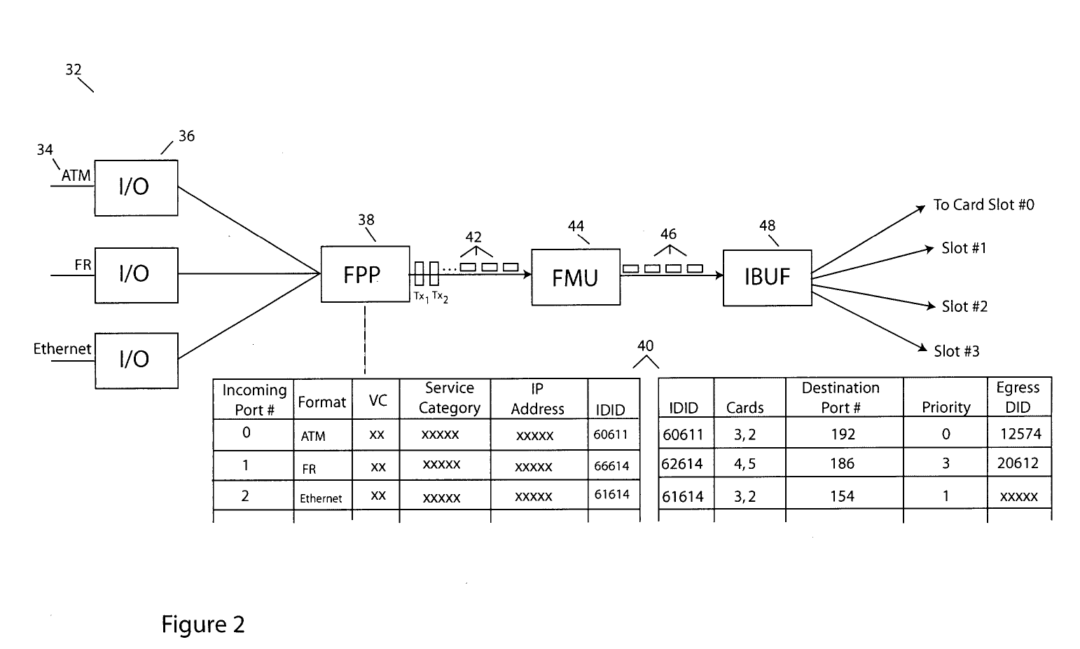

FIG. 2 is a graphical representation 32 of an input interface 18 used in the illustrated embodiment of the invention. Three components of the input interface are the Fast Pattern Processor (FPP) 38, Flow Management Unit 42, and the Ingress Buffer (IBUF) 46. FPP 38, is a commercial-off-the-shelf product, available from Agere, that receives data 34 from the external I/O cards 36 via a POS-PHY bus. Of course, other such devices, regardless of source, may be used instead. The FPP 38 performs AAL5 PDU reassembly, packet classification, level 2 forwarding, level 3 and level 4 forwarding and policing, all based on configuration data maintained in table 40.

More particularly, FPP 38 reassembles the data 34 and performs such classifications as are necessary to forward it through the network device 10. Transaction Ids are also appended to the data by the FPP 38. The reassembled data, known as protocol data units (PDUs) 42, are then output from the FPP 38 as 64 byte transactions and sent to the Flow Management Unit (FMU) 44. The FPP 38 denotes the end of transfer of each PDU 42 with a transmit command, e.g., Tx0, Tx1, Tx2. The transmit commands include IDIDs and other classification results, e.g., length, offset, flag bits.

Responsibilities of the FMU 44 include: 1) reordering, 2) reassembly and 3) segmentation of data into proprietary cells (GCells). The FMU 44 reassembles the data back into full PDUs by loading the incoming 64 byte transactions 42 into 64 byte buffers. Each transaction 42 is buffered until the entire PDU is received, as indicated by the transmit command. The FMU 44 then segments the PDUs into the aforementioned GCells 46, which are comprised of a 12 byte header and a 52 byte payload. The header includes parameters such as priority, port number, and egress ID. The reassembled linked-list of buffers that constitutes a packet is enqueued on one of four priority output queues that are emptied one GCell at a time, in a high to low priority scheme. The dequeued GCells 46 are sent to the Ingress Buffer (IBUF) 48.

Illustrated IBUF 48 forwards GCells 46 from the FMU 44 to the mid-plane high-speed cross-connect (See FIG. 1, item 20) and associated cards (See FIG. 1, item 16) based on card slot mask as defined in the configuration table 40.

A more in-depth understanding of the functionality of the input interface (See FIG. 1, item 18) comprised of the elements illustrated in FIG. 2, e.g., FPP, FMU, IBUF, may be realized by the following discussion. It will appreciated that this discussion pertains to an embodiment of a system utilizing the invention and that other architectures, components and operations may be used instead to the extent consistent with the invention.

Fast Pattern Processor (FPP)

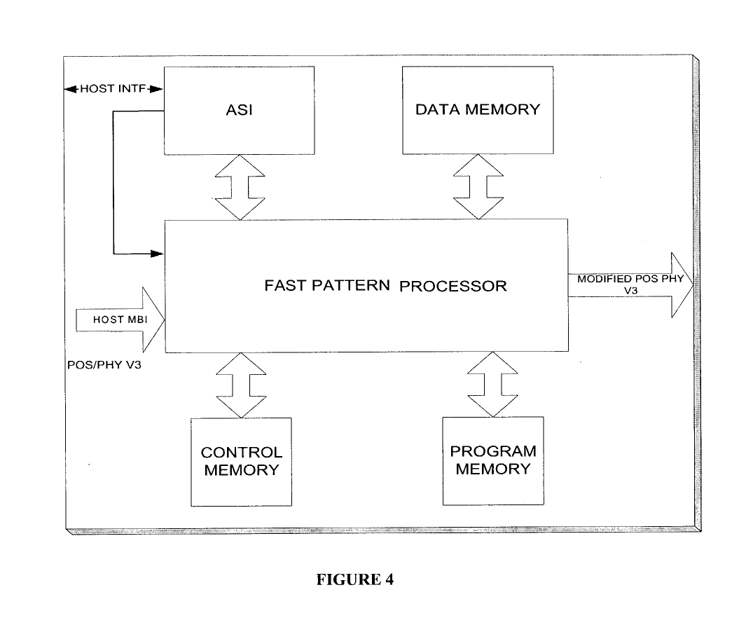

Referring to FIG. 4, the Fast Pattern Processor receives data from the external I/O Card (See FIG. 1, item 14) via a POS-PHY or UTOPIA bus and performs the following functions.

1. AAL5 PDU reassembly

2. Packet classification

3. Level 2 forwarding

4. Level 3 and Level 4 forwarding

5. Policing

The FPP is programmable using an Agere-proprietary functional language called “Functional Programming Language” or FPL.

FPP Functionality

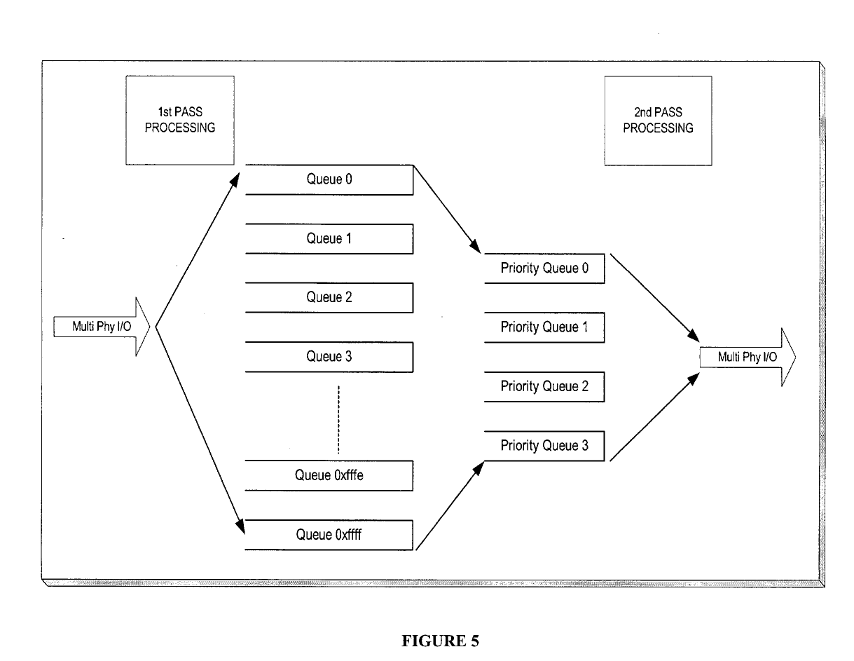

User data is received from the I/O card and is processed as it moves into Data Memory, with the help of data structures in the Control Memory and the parse tree in the Program Memory. The result of the processing is stored in the Control Memory. Datagrams (PDUs) are stored in the Data Memory in one of 64K linked-listed queues. These queues are then linked onto one of four priority queues. These priority queues are then read from the Data Memory and processed one more time for layer three to layer 7 processing. The processed datagram is then sent out to the FMU on a modified POS-PHY interface. This process is shown pictorially in FIG. 5.

Statistics are stored in the ASI memory by the FPP, via a call to the ASI. The counters are numbered and installed in the ASI memory. Software associates counters to physical interfaces, logical interfaces, flows or classifications, etc. These counters' numbers are then passed on to the ASI, which actually increments the values in byte/cell counts or packet counts.

The FPP is a two-pass engine. The first pass is used to parse layer 2 headers as data moves from the I/O card into the Data Memory. The second pass is used to parse layer three to layer seven headers as data moves from the Data Memory to the FMU.

First Pass Processing

During first pass, data is stored in Data Memory by the FPP and the header of the datagram is sent to a compute engine to parse Layer 2 header information. Since the compute engine can take time, multiple (up to 64) such datagram headers are processed in parallel. The result of the processing yields four parameters, a) Queue number, b) Offset, c) Priority and d) Tag. The Queue number is a 16-bit number representing which one of 64K Queues (shown in FIG. 5) to enqueue the datagram on. The Offset parameter determines the start byte for ‘replay’ during the second pass, within the header of the linked-listed datagram. Priority is one of four priority classification queues the datagram belongs on. Finally, Tag identifies the Parse tree root for the second pass. All four parameters, along with head and tail pointers of the packet, are stored in the Control Memory.

Second Pass Processing

During the second pass, data from priority queues are moved out of the Data Memory and passed on to the FMU. Data to be processed is prioritized based on the priority queue; a simple priority scheme is implemented. The data is played through one of 32 available replay engines. As a new datagram is removed from the Data Memory, the processing starts from the Offset (extracted during the first pass), which is stored in the Control Memory. The parsing is started from the ROOT of the parse tree as specified in the Tag parameter derived in the first pass. The outcome of the second pass includes a) Destination ID, b) Offset, c) Parameters. The Destination ID is a value that is stored in Program Memory and is a result of the classsification tree lookups. This Destination ID binds the egress port in the system to this processed datagram. Offset is a pointer in the datagram that indicates to the RSP to ignore the datagram up to the offset mark. This is a mechanism to normalize the datagram across the mid-plane.

AAL5 Reassembly

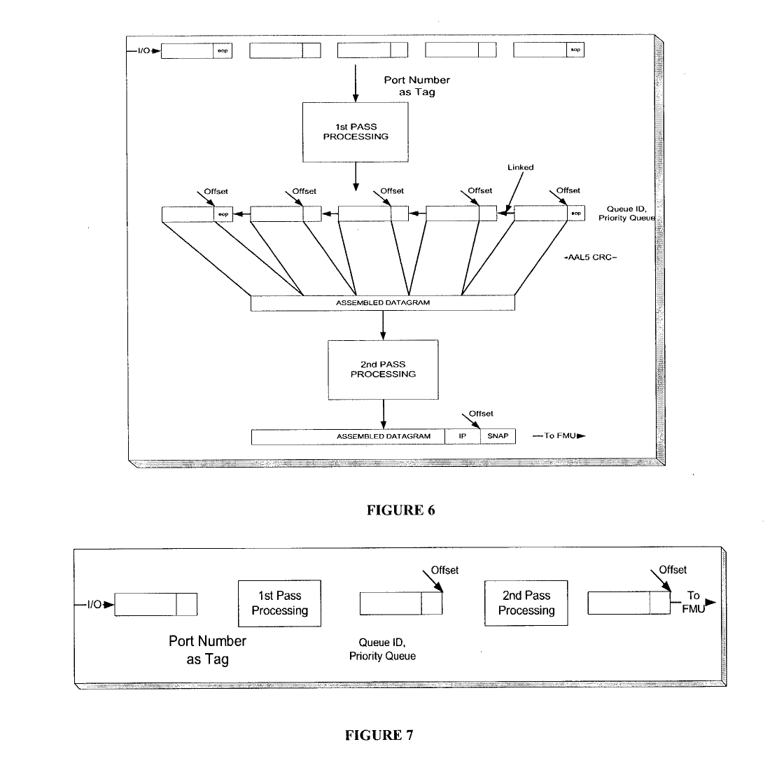

This subsection will functionally explain the process of setting up AAL5 assembly streams using the FPP as shown in FIG. 6. A stream of five cells, belonging to a single frame (PDU), arrives at the FPP non-sequentially. The first pass processing unit will process cells and, based on the VCI/VPI lookup, it will set up a Queue Number and an Offset for all cells of the datagram, and store them on a predefined Queue.

When the last cell of the packet (PDU) arrives, it is enqueued on the same queue and then that queue is linked to an output priority queue, based on the predetermined priority for the stream. As cells are queued up in Data Memory, the Offsets of the cells are set to the base of the cell header. This indicates to the 2nd pass processor to ignore data in the cell header.

When the priority Queue is dequeuing the datagram, it will only read the cell body and construct a contiguous datagram. As it is constructing the datagram, three things are happening: a) AAL5 CRC is being performed, b) the assembled datagram is being sent to the FMU, and c) the datagram is being parsed for layer 3-7. The result of the parsing may produce another Offset value, which is sent to the FMU for further normalizing the Mid-plane datagram format.

Cell Switching

With reference to FIG. 7, this section details how FPP provides Level 2 switching. For this example, ATM is used and not Frame Relay.

In ATM cell switching, the cell is sent to the first pass processing engine with a port number as Tag. The Parser will parse the header and return a Queue ID, Priority, and a Tag for the second pass. The cell is stored in the queue pointed to by Queue Id, and put onto the provisioned priority queue. On the second pass, when the cell is at the head of the priority queue, the 2nd pass processing engine will use the result of the 1st pass Tag and start to parse the cell. The result in this case should be the DID value for the (L2) switching case. The Offset for the second pass should be the start of the datagram. A similar case can be constructed for Frame Relay, except the datagram would be multiple cells.

Packet Classification

Packet classification is a secondary implicit result of parsing the VP tree. The result of the parse always results in a DID. This value is overloaded and contains the Queue number of the service that the corresponding datagram should experience while in the platform.

Policing

Each incoming PDU or cell stream can be monitored for in-profile or out-of-profile according to the corresponding SLA for that stream. If an incoming stream is already marked as out-of-profile (via DE or CLP indications), then policing bit x is set in the first pass Tag parameter. If an incoming stream is marked as in-profile but the policer determines that the stream is actually out-of-profile, then either the tagging bit is set or the PDU/cell is discarded.

Transmitting Host Packets

Host can send Inter-Processor Communications (IPC) packets via the FPP using the Host Interface. IPC data should be formatted by the host just like any other packet-based I/O. The FPP parser should be setup with the IPC parsing pattern(s) prior to sending IPC data. Data on the Host interface is treated exactly like data from the I/O port—this could also be used for diagnostics to test the part.

During its 2nd pass, the FPP replays data from SDRAM from one of four priority queues through one of 64 possible contexts. If data from a single input flow (from the same port) is queued up on the same priority queue, then there exists a chance that the PDUs will get out of order when they exit the FPP. The FMU is supposed to reorder them before they are sent to the egress.

FPP I/O Interfaces

The FPP has four I/O interfaces (plus memory buses). Each one is listed below

FPP -> FMU Interface

This interface is a modified multi-PHY POS-PHY interface. The interface numbers do not reflect the ingress port numbers; however they reflect the context numbers on the FPP through which the data is sent. This interface could be functionally thought of as a multi-link PPP. The next functional block, FMU, has to reorder datagrams on a priority, similar to multi-link PPP.

FPP <-> ASI Interface

This interface is a set of three proprietary buses connecting the ASI to FPP/RSP.

FBI (Functional Bus Interface)

This is a proprietary bus and its use is abdicated by Gotham Networks. The FPP and ASI use this bus to support features like Statistics, Policing, special functions etc.

CBI (Configuration Bus Interface)

This is a proprietary 8-bit (modified POS-PHY L2) interface between the ASI and other Agere devices. It is used to configure these devices and to dynamically update the FPP's pattern-matching tables. No user traffic goes on this bus.

MBI (Management Bus Interface)

This is an 8-bit POS-PHY L3 (single-PHY) interface, which allows a Host CPU to send data through the FPP. Control information or Node IPC messages are also transmitted over this interface.

FPP Memories

The FPP has the following three memories connected to it.

Data Memory

This memory stores user data after it is received from the I/O card via the POS-PHY or UTOPIA interface. The data is stored in unit blocks of 64 byte buffers. The data is managed via linked-lists of pointers, which are stored in the Control Memory. Complete datagrams, consisting of multiple linked buffers, are organized into 64K queues. Each of the 64K queues is assigned to one of four priorities by software using the FPL program. However, software does not have any direct access to the Data Memory block.

Control Memory

This memory stores the 64K queue linked-list pointers and the Free buffer linked list. It also stores the four priority queues' management pointers. It also stores additional data on a per packet linked-list basis. All this information is manipulated by the FPP internally and is not visible to the software.

Program Memory

This block of memory stores the parse tree, similar to a VP Tree. The parse tree is a proprietary and patented algorithm, which allows the Host Processor to install header parse criteria, and the FPP can then parse these headers at wire speed up to OC48 rates. Program memory is not directly accessed by the Host Processor. FPL allows software to indirectly install parse statements into this memory.

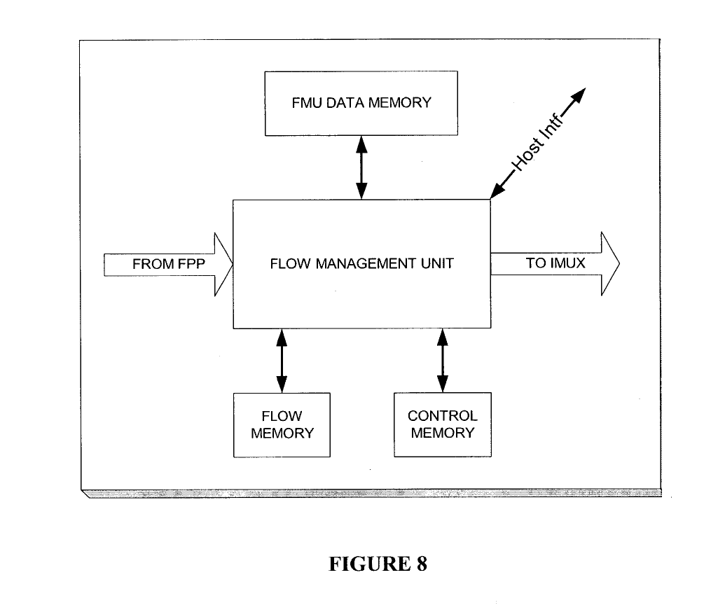

Flow Management Unit (FMU)—FIG. 8

The FPP sends data in a proprietary way on a modified POS-PHY bus. The data is interleaved on up to 64 contexts or logical ports. A datagram from a single context (or logical port) is not interrupted. However, there is a reordering issue that can occur amongst the context streams. That is, a datagram on context y may finish before context x (logical port x), even though the datagram on context y (logical port y) appeared later on the same physical port than context x (logical port x).

In the discussion that follows, the term “context” and “logical port” are used synonomously. Though use of the former term is more prevelant, those skilled in the art may deem it more aptly intepreted as the latter term.

FMU Functionality

The FMU accomplishes its functions as follows.

Reordering

Reordering is a problem introduced by the FPP during its 2nd pass. A single FPP priority Queue is played through one of 64 contexts simultaneously. A context during any given time transfers a packet through in its entirety. However, due to the variability of the packet size, the FMU receives end of packets in such a way that it could receive packets out of order. The problem is very similar to multi-link PPP. There are four reorder lists, one for each FPP priority. There is no software setup or monitoring required.

Reassembly

The FMU has to reorder packets, but reordering can only be done when complete packets are assembled; therefore Reassembly is a side effect of Reordering. Reassembly is done by stuffing the data into the 64 byte buffers.

Segmentation to Gotham Cells (GCells)

The reassembled linked-list of buffers that constitutes a packet are enqueued on one of four priority output queues in the FMU Data Memory. These queues are emptied one GCell at a time, in a high to low priority manner. The Header space in the Data Memory not used during the Reassembly is used to fill the Gotham Header.

Flow Memory stores 128K Flow Entries. Software will initialize each entry before a connection is established. The DID from the FPP is used as an index into the FMU table to extract the GCell header information. The elements of the table that software can update are itemized below.

Egress DID: This is the DID that is used by the RSP on the egress Card.

Egress Priority: This is the priority that is used by the egress card's QP in a single chassis node.

Egress Destination Logical Port (logical port locator): This is the egress logical port number for this datagram on a single chassis node. • Egress Mask: This is a 16-bit mask that indicates which slots in the shelf are to receive the datagram. (Note: the Egress Mask is not directly assigned. Software will examine the local Slot_ID to determine how to map the bits within the Egress Mask for the FMU in each slot.)

Drop Type: This two-bit field defines whether packet or cell dropping algorithms are to be run on that flow.

Besides the above items, software has to setup the following registers in the FMU:

Ingress card Number: This indicates the slot number of the chassis this FMU is on.

Chassis Number: This indicates the chassis number of the node.

FMU Interfaces

FPP Interface

The FPP presents a modified Multi-PHY POS-PHY transmit-only interface, operating with a 32-bit data path, clocked at 100 MHz. Further details of this interface are listed in [2]. Packet fragments are sent using flow control and SOP/EOP indicators as specified by POS-PHY standards. The port number (Multi-PHY address) on the POS-PHY interface represents one of 64 context IDs of the FPP. This takes up 6 of 8 possible bits in the Multi-PHY address field. After the transfer of a packet fragment with the EOP indicator set, an FPP ‘Transmit Command’ is issued for that packet, containing the results of the first and second pass processing. The FPP indicates a ‘Transmit Command’ by setting the MSB of the port number (Multi-PHY address) on the POS-PHY interface.

IBUF Interface

This interface has two busses, a) GCell Bus and b) egress mask. The GCell Bus is a 32 bit data bus clocked at 100 MHz. The FMU is the master of the GCell Bus and provides both clock and data. There may be control signals that indicate start and end of cell. Along with the GCell Bus, there is a 16-bit Egress Mask, indicating which slot to send the corresponding GCell to.

HOST Interface

Host Interface allows the Host MPU to set tables in the FMU.

FMU Memories

FIG. 8 above shows a block diagram of the Flow Management Unit. The FMU has three memories associated with it, a) Data Memory b) Flow Memory and c) Control Memory.

Data Memory

This is a relatively small memory responsible for storing 256K 64-byte packet fragments. Software has diagnostic-only visibility into this memory.

FMU Flow Memory:

This memory stores GCell header information per DID that helps in classification and routing of user traffic from the FPP to the egress. Software is responsible for setting up this table. Byte, buffer and packet level information is stored in this memory.

Control Memory:

This memory keeps track of buffers of Data Memory in four priority queues. The priority information is sent along with each buffer from the FPP. Software has little or no visibility into this memory.

Ingress Buffer (IBUF)

The IBUF is responsible for forwarding GCells to up to 16 egress Mid-plane transceivers. It receives the GCell Bus, the local 100 MHz clock, and the Egress Mask from the FMU. Note that this mask is bit-encoded so that more than one destination card may be selected in a multicast scenario.

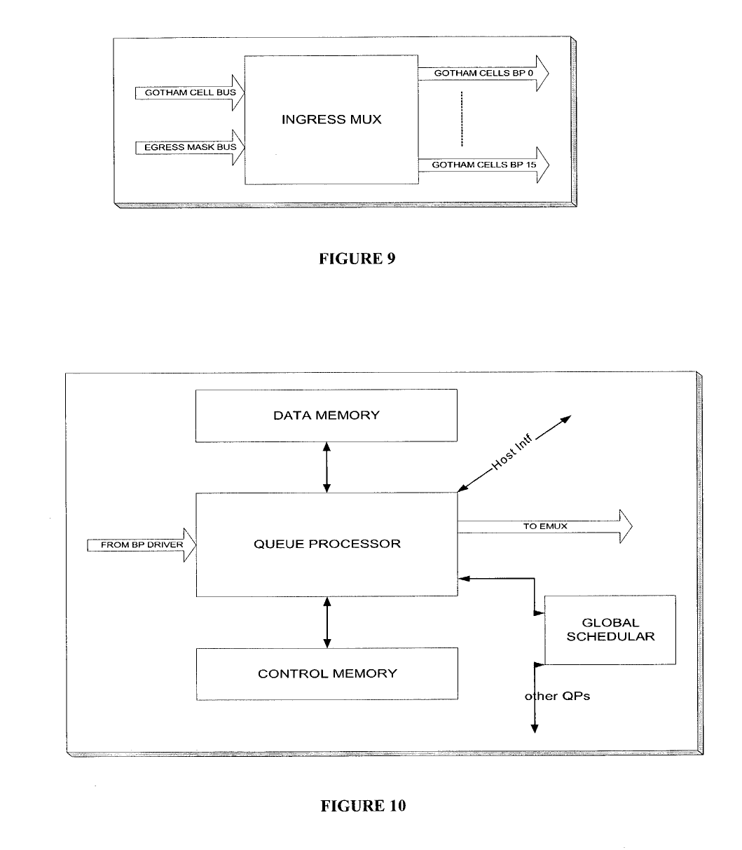

The functional block diagram of the IBUF is shown in FIG. 9. There are no software setups required to the IBUF. There are no memories connected to the IBUF and the interfaces are GCells in and out.

Mid-Plane High-Speed Cross-Connect

The mid-plane high-speed cross-connect delivers GCells to the egress portion of the destination card. The cross-connect subsystem is responsible for reliably transferring GCells to other slots in the shelf that have been enabled via the Egress Mask. The high-speed cross-connect also ensures that the plesiochronous elasticity buffers do not over- or under-flow.

Queue Processors

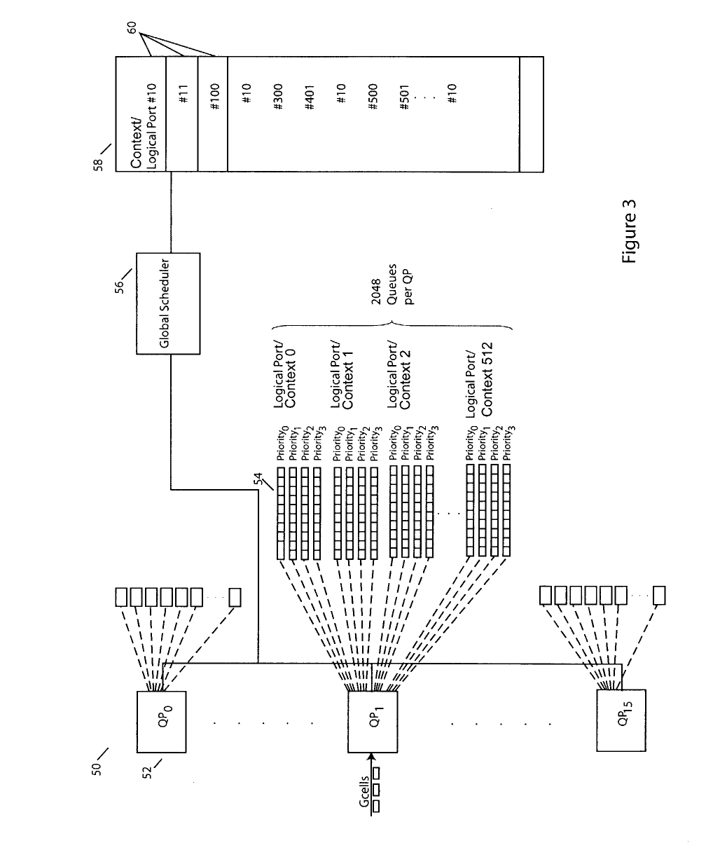

FIG. 3 depicts a graphical representation 50 of the interrelationship between the queue processors 52, and an associated scheduler 56. The queue processors 52 are each associated with a plurality of queues 54 into which received data is stored per context and per priority. In one embodiment, each queue processor 52 is associated with a respective group of four priority queues 54 for each of 512 output contexts (for a total of 2048 queues), though other numbers and combinations can be used instead.

The data contained in each queue 54 is normally dequeued according to its priority level. Referring again to FIG. 3, the scheduler 56 is coupled to the plurality of queue processors 52 and schedules the dequeing of data from their respective queues 54 for transfer to the corresponding output interface (see FIG. 1, item 26). The scheduler 56 polls the queue processors 52 to identify which has queues requiring service in accord with an order determined by a scheduling table 58. This has a plurality of entries 60, each containing a context number, aggregation mask and a master flag. The scheduler 56 reads the table entries in round-robin fashion, visiting each entry 60 periodically, e.g., every 130 ns, to determine a context number to be serviced. The scheduler 56 then polls all the queue processors 52 to identify which ones have data ready to transfer for that particular context. All queue processors 52 that do, signal the scheduler 56, which then selects one of them to dequeue its data to the output interface, e.g., reassembly processing unit, routing switch processor. The scheduler 56 then moves on to the next table entry 60 and continues the process. The table 58 is loaded at configuration time to include a sufficient number of entries 60 per context to ensure guaranteed quality of service for the destination network in view of its throughput. This pre-loading of table entries 60 makes it possible for the scheduler 56 to repeatedly poll the queue processors 52 multiple times, if necessary, with respect to a particular context.

When the queue processors 52 are polled by the scheduler 56 with a given context number, they signal back with the priorities of the data they are holding for that context. They also signal back to indicate whether any given queue 54 is “starved”, i.e., has not been serviced within a specified threshold period. The scheduler 56 normally schedules queues for dequeing based on priority, but will service starved queues before all others. This can result in starved queues receiving higher priority than non-starved regardless of their initial priority level.

In the illustrated embodiment, the starve indicator is a counter that is initially set to a threshold value such as, by way of non-limiting example, zero. Each time that the scheduler 56 does not schedule dequeing for a corresponding queue 54 in need of service, the starve indicator is decremented. The queue is considered to be starved whenever the indicator value is below zero. When the corresponding queue 54 is finally serviced, the starve indicator is stepped up (well into the positive range) by a specified amount, e.g., +10. In alternate embodiments, the starve indicator can be set to an initial numerical value other than zero and incremented or decremented by uniform or non-uniform amounts each time the corresponding queue is not serviced. It can be reset to the original amount or to another amount (e.g., positive or negative) when the queue is finally serviced.

The aggregation mask that is associated with each entry 60 of the scheduling table 58, indicates (if activated) that dequeing of data is only permitted from starved queues. The scheduler 56 responds to the aggregation mask by scheduling dequeing of associated starved queues. The advantages of this configuration include, preventing unwanted bursting, e.g., for ATM-CBR (Asynchronous Transfer Mode-Constant Bit Rate).

The master flag that is associated with each entry 60 of the scheduling table 58 is used to indicate (if activated) that starved signaling to the scheduler 56 from the queue processors 52 is to be taken from one queue processor 52 only, e.g., QP0. It thus serves as a single set of bandwitdh calculator for all queue processors 52 for that priority and logical port number. The master flag is used to ensure that only the one bandwidth calculator is used for all QPs for that logical port and the resulting bandwidth result is shared by all QPs to reflect cumulative queue activity.

A more in-depth understanding of the functionality of the queue processors and scheduler may be realized by the following discussion.

QoS Subsystem (Quality of Service)

The functional diagram of the QoS module is shown in FIG. 10. This module provides the QoS (Quality of Service) per flow on the ingress side and also the switching without a switch fabric on the output side. Two components are the Queue Processors (QPs) and the Global Scheduler (GS), also referred to as the scheduler. In the illustrated embodiment, there are 16 Queue Processors on a card, which are serviced by a single Global Scheduler.

Data is stored in the QP Data Memory in linked-list fashion on logical queues. The total number of queues Nq is equal to the product of the number of logical ports being serviced by this card's egress interfaces times the number of priority levels supported, plus the number of queues dedicated to IPC traffic (=one virtual port times the number of IPC priority levels.) Therefore, the Control Memory manages a total of Nq queues in the Data Memory. The Global Scheduler is responsible for selecting a QP, and the corresponding queue in the QP, to dequeue, based on the available bandwidth and the pre-defined Service Level Agreements (SLAs). Once a queue is selected for dequeuing, the GCell at the head of the selected queue is sent to the EMUX.

The following are the sequence and tasks performed by the QP's:

Receives GCells from the mid plane

Stores GCells into QP Data Memory

Maintains a linked-list of buffers per Queue Index in Control Memory.

Dequeues GCells with the help of Global Scheduler

Performs Discarding based on Tail Drop, EPD, PPD, and Frame Dropping.

Maintains a detailed list of statistics.

QP Functions

The Queue Processor includes the following functional blocks: an Enqueue Unit, a Dequeue Unit and a Dequeue Control Block, which are explained below.

Enqueue Unit

This unit is responsible for receiving data from the mid-plane transceivers and storing it into the Data Memory, at an address pointed to by the head of a free list maintained in Control Memory. The Enqueue Unit will also then attach the buffer to the corresponding queue. The queue number is extracted from the header of the receiving cells, formed by Logical Port and Priority Number. There can be one cell enqueued during 160 nsec time.

Dequeue Unit

The unit is responsible for dequeing data from the head of a Queue. The Queue is selected with the help of the Global Scheduler and the Dequeue Control Block. Once a cell is dequeued from the Data Memory, it is transmitted to the EMUX unit. The cell that is dequeued is put back onto the tail of the Free List. The tail of the free list is in a register in the QP, while the free list itself is in the QP Control Memory.

Dequeue Control Block

The Dequeue Control Block is responsible for ensuring the bandwidth per Priority on a logical port is departed precisely. The DCB works with a set of data stored in the Control Memory that represent an accumulator and a Step size value per queue on the egress port.

During a cell time slot, the DCB and the Global scheduler decide which priority on a port will be dequeued. The DCB's task is two fold, a) to find the queue that needs servicing, and b) update the next-time-to-service per queue based on it being serviced or not serviced. Once the update of the next-time-to-service is calculated for each queue, the values are stored back in memory.

QP Mid-Plane Interface

Data arrives from the Mid-plane transceivers as 32 bits every 10 nanoseconds. The data arrives as GCells of 64 bytes in length (16 clock ticks). This interface is packet oriented, wherein GCells comprising a packet arrive in order, per priority level. Since there are four priorities, there can be up to four intermixed streams arriving at any time. There may be hardware indicators from the Mid-plane transceivers that indicate start and end of GCell.

QP EMUX Interface

When a GCell is dequeued from QP Data Memory it is sent to the EMUX in a single cell time. There can be only one cell going to the EMUX from the 16 QPs at any given time. The Global Scheduler ensures this by selecting a single queue on a single QP. This interface is also 32 bits wide and runs at 100 MHz. There may be accompanying control information like start and end of cell indicators.

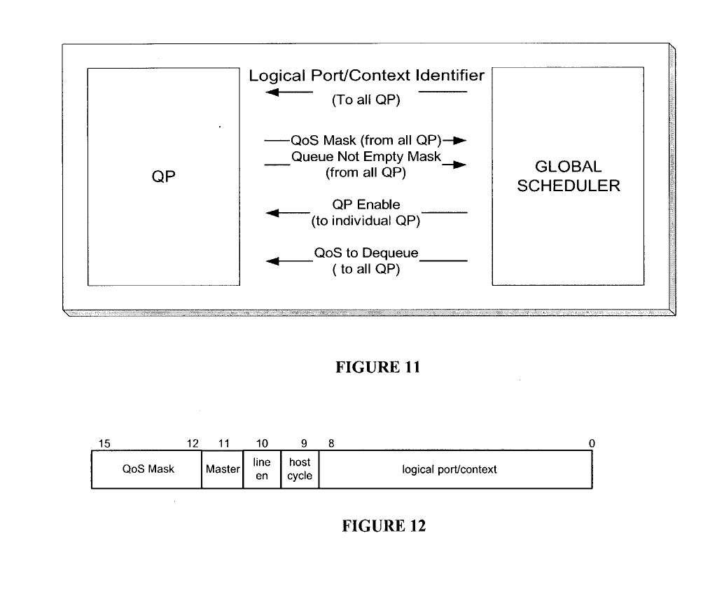

QP Global Scheduler Interface—FIG. 11

This interface ties the QP's to the Global Scheduler and performs the core of the switching. The interface is shown in FIG. 11. The handshake between the Global Scheduler and the QP runs at 160 nsec, or one GCell Time. During the GCell Time, the Global Scheduler sends a logical port indicator to the QPs to indicate which egress logical port needs servicing. The QPs respond with two masks, one indicating Queues that are starved, and the other indicating Queues that are not empty. These masks summarize queues that are ready to send, at each priority level. The Global Scheduler then examines these masks and selects a QP and a queue for subsequent dequeuing during the next GCell Time.

QP Memories

QP Data Memory

QP stores GCells in Data Memory. This Data Memory is preferably at least 4 MB deep, holding 64K GCells. On the upper end this memory could be 16 MB, holding 256K cells. This memory has a total bandwidth requirement of ˜6.5 Million GCells per second in and out. The memory is divided into two physical banks. At any given cell time, the enqueue block is writing to one memory while the Dequeue block is reading from the other bank. The enqueue block only writes, and the Dequeue block only reads. The Host Processor has diagnostic-only access into this memory.

QP Control Memory

The QP Control Memory stores the following. The size of the memory is dependent on the size of Data Memory.

Queue Head and Tail pointers

Free List Head and Tail pointers

Queue Linked Lists

Free Linked List(s)

Statistics

DCB parameters

The Host processor does not have direct access to the memory during run time. However it can post data for parts of the memory to install queue values. The size of the memory is directly proportional to the number of queues and the number of cells in the data memory.

Global Scheduler, GS

The Global Scheduler is the mechanism used to schedule dequeing of data from a Queue Processor. The whole scheduling process will select a specific Queue Processor, one (1) of sixteen (16), and a specific QoS queue, one (1) of four (4), within the selected Queue Processor. Queue Processors are selected on a round robin scheme. The QoS queues are selected on a priority scheme, QoS queue zero (0) has the highest priority level, and QoS queue three (3) has the lowest priority level.

Functions

The Global Scheduler has to calculate the QoS and Queue Processor select every 160 ns. There are three possible criteria to consider in the selection process:

Committed traffic available, a queue requires dequeuing to meet a SLA

Aggregate traffic available

The three criteria are listed in order of priority.

QoS Select

The QoS select for all two criteria Committed and Aggregate are considered in parallel. The decision as to which selects actually go to the outputs is done later. It is done on a per GCell cycle basis. The selection is the highest priority level that has a GCell to dequeue is selected.

QP Select

The QP select for all two criteria Committed and Aggregate are considered in parallel. The decision as to which selects actually go to the outputs is done later. QP select is done on a per logical port/QoS level. There are two groups of QP pointers, one for each process, Committed and Aggregate. The QP pointer values range from zero to fifteen. The current QP pointer points to the last QP that was allowed to dequeue. The selection of the next QP pointer will start at (current QP pointer+1), and so on.

GS Hardware Interfaces

GS QP Interface

The interface between the Queue Processor and the Global Scheduler is a simple request and grant handshake. Each of the Queue Processor presents the GS with request information, starved and ready. The request information is presented every 160 ns. From the starved and ready information the GS will generate QoS and QP selects for each of the two criteria. Based on the priority of the criteria the proper selects are driven back to the Queue Processors. Each of the Queue Processor will receive one of fifteen QP selects, and a four bit QoS select bus. There are two copies of the QoS select, each copy is wired to four Queue Processors.

GS RPU Interface

Start of GCell

The Queue Processor will give the RPU a 10 ns pulse to indicate the start of a GCell. The Global Scheduler also gives the RPU the source Queue Processor ID of the GCell. The Queue Processor ID is valid on the first word of the GCell, and stay valid for the entire cell time.

Backpressure

The RPU is responsible for notifying the Global Scheduler that backpressure if required. The Global Scheduler receives four backpressure signals from the RPU. Software will associate any group of four of the eight backpressure signals to the four QoS levels. When the selected backpressure signal becomes true, the corresponding QoS level will stop forwarding traffic.

GS Scheduling Table Interface

Referring to FIG. 12, in the illustrated embodiment, the Global Scheduler interfaces to a 256 k×16 asynchronous SRAM. There are two SRAM cycles every GCell time, 160 ns. The first 80 ns. is always a read, the second 80 ns can be either a read or a write. The first read is to retrieve information on the next egress logical port.

If the master mode bit is set in the scheduling table entry then the starved information from all but the master queue processor in ignored.

Bits 12 to 15 represent the QoS mask for this logical port. This information is used in the calculation of the QoS level for the aggregate path. A zero in any bit position in the mask will prevent the corresponding QoS level from being selected for dequeueing when not ready.

GS Host Interface

The Host interface is a PCI pass thru interface. In the illustrated embodiment, it runs at 33 MHz.

Egress Mux

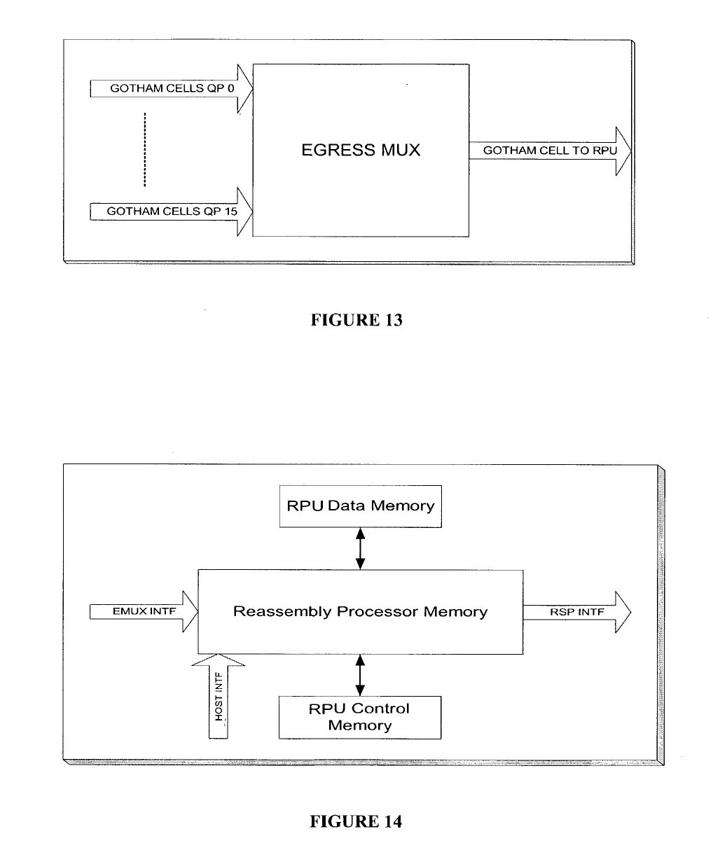

This module is responsible for forwarding GCells from 16 QPs to the RPU block. The functional block diagram of the EMUX is shown in FIG. 13.

There are no memories connected to the EMUX and the interfaces are GCells in and out. The Global Scheduler (GS) is responsible for enabling the appropriate QP to send GCells through the EMUX.

Referring again to FIG. 1, the output interface 26 is comprised of a Reassembly Processing Unit (RPU), and a Routing Switch Processor (RSP) that transfer received data to one or more respective network connections 30. Each output interface 26 receives all its incoming data from a respective plurality of queue processors 22 via a single respective EMUX.

A more in-depth understanding of the functionality of the output interface (See FIG. 1, item 26) comprised of a RPU, and a RSP may be realized by the following discussion and by reference to the document entitled “Router Switch Software Architecture Specification” contained in the appendices of U.S. Provisional Applications Nos. 60/272,387, 60/272,407, and 60/272,328 as well as the other documents contained in those appendices, the teachings of which are incorporated by reference herein.

Reassembly Processing Unit (RPU)—FIG. 14

This Unit is responsible for forwarding data from the EMUX to the RSP in a format that the RSP can understand. The RPU receives GCells from the EMUX. RPU transmits packets to the RSP in a modified POS-PHY interface. Functions performed on the RPU unit are a) Reassembly, b) Reassembly Time-out (RATO) support, c) prioritization, and d) POS-PHY conversion during transmit. The RPU block diagram is shown in FIG. 14.

RPU Functionality

This section will explain each of the four functions that the RPU performs.

Reassembly

As data arrives from the EMUX, the Queue Index (Logical Port.Pri) and the QP number are used to lookup the Tail pointer for that queue in the RPU Control Memory. The RPU gets a cell buffer from the Free List Head and stores the data into RPU Data Memory at that cell address. The new cell is appended to the queue and the Tail pointer updated. Similarly, the Free List Head Pointer is updated to point to the next available free buffer. When the four items (queue index, new queue tail, new free list head) are processed they are written back to the Control Memory.

If a GCell is received with EOP set, the cell is enqueued and the Head and Tail pointer are placed (or merged) onto one of the 64 output transmit lists. Once this is accomplished, the Head and Tail pointers are cleared (the reassembly is complete), and a Transmit Command is generated for the now-complete PDU. This mechanism implies that packets (PDUs) are forwarded based on the arrival time of the EOP if they are on the same priority.

Prioritization

Inside the RPU are 64 independent linked-listed queues. Each queue has a Head and Tail Pointer. 64 queues are split amongst 16 physical ports, 4 prioritized queues per physical port. Prioritization process will first group all 64 queues in four priority groups each with 16 ports. The data is then pushed through the RSP interface in high to low priority manner. Within each priority group there is a round robin for ports.

RATO

Reassembly Time Out is a process that allows the RPU system to ensure that a group of buffers are not hung in a particular queue waiting for a GCell with EOP set. This can be accomplished in multiple ways. It involves setting a bit per reassembly Queue that gets cleared every time a cell is added to the queue. Also asynchronously there is another process that polls each queue, testing for 1 [and then writing a 1 in the same bit]. If, during testing, it finds the queue is not empty and that there is a one in the RATO location, it frees up the buffers in the queue. The polling interval could be set to be slow, in 100's of msecs. Therefore this polling and setting could be done by the Host processor also.

POS-PHY Conversion

This process involves reading a data from the Data Memory and converting it into POS-PHY format and sending it to the RSP. Following each packet, the RSP sends a Transmit Command.

RSP Backpressure

RSP sends a two-bit backpressure indicator to the RPU. One bit indicates a full halt, whereas the other indicates to “stop new packets”. In the first case, the RPU should not send any data, and freeze the EMUX-RPU interface. In the second case, the RSP should stop reading the head of the reassembly queues, i.e. do not start new packet.

EMUX (GS) Backpressure

Four bits are defined that apply backpressure to the EMUX (via GS), one per priority. Each bit represents a condition that tells the EMUX to stop sending GCells from the corresponding priority queues. The total number of free buffers in the RPU is monitored to determine if backpressure is warranted. There is one watermark per priority level (nominally 4) to trigger backpressure when buffers become scarce. Software can set these watermarks via RPU registers.

RPU Interfaces

EMUX Interface

This interface is purely GCells. The RPU may also apply backpressure to the EMUX via the GS. The GCells arrive at a worst-case rate of 32G/(64*8)=6.25M Cells per second.

GS Interface

The RPU may decide to reduce its input load when resources become scarce. To this end, the RPU may apply a PHOLD signal to the Global Scheduler GS, at each priority level. These signals indicate to the GS not to forward GCells at that priority until the PHOLD signal is removed. Only whole cells are ever transferred, so at least one additional full GCell may arrive at the EMUX after assertion of PHOLD.

RSP Interface

The RSP Interface (from the RPU to the RSP) is similar to the interface from FPP to FMU (modified POS-PHY.) In fact the RPU emulates the FPP interface. This interface transfers 32 bits of data at up to 100 MHz. In this case, the RPU acts as the Transmit master with the RSP acting as the Transmit slave.

The RPU uses up to 64 reassembly output queues—e.g., four each for 16 physical ports on the I/O. Each of the four queues represents a priority level on the output physical port. The RPU will also reconstruct and send an Agere Transmit Command after each packet is sent to the RSP.

The interface is driven by Reassembly Queues inside the RPU. In the illustrated embodiment, there are 64 reassembly queue head and tail pointers. The queues are linked lists of GCells in RPU Data Memory. Based on the priority of the queues, data is sent to the RSP. The RPU is responsible for stripping the GCell headers and assigning the correct context (Multi-PHY address) to the data blocks and the Transmit Commands.

RPU Memories

RPU Data Memory

RPU Data Memory stores data from the EMUX in a linked-list fashion. Data arrives as GCells from the QP via the EMUX. Each of the QPs sends GCells from one of possible Context.Pri queues (hereafter referred to as Reassembly Queue Index or RQID). Given 16 QPs on the card, there would be 32K (=512*4* 16) total such interleaved reassembly flows arriving at RPU simultaneously. Therefore the worst-case RPU Data Memory size is 32K*MTU or 256 MB of memory for an 8 KB MTU. The system allows for statistically multiplexing up to 128K simultaneously-active MTU reassembly flows and hence provides 512 MB of memory. This would allow for 64K GCells, and utilize a 16-bit Cell address. The Host Processor does not need to interface to this memory during run time. However, diagnostic access (read and write) is provided to this memory.

RPU Control Memory

The RPU Control Memory is used to manage the RPU Data Memory and tracking reassembly processing. This memory holds the following data structures.

Reassembly Head and Tail Pointers, Free List Head and Tail Pointers

There are 128K worst-case reassemblies at any given time. For each reassembly queue there is a head and a tail pointer, each of 16-18 bits. The RPU looks up the Queue Index (Context.Pri) from the GCell and indexes into this part of the control memory and links the GCell on the Tail. The size of this memory is 32 k*36.

One head/tail entry is reserved for the Free List, which holds a queue of available RPU Data Memory cells (this could also be internal to the device). When a Cell is made available again, after dequeing, its address is linked to the tail of the Free List.

Free List

This memory stores the linked lists of cells that are either free or in use by reassembly queues. Each entry in this list stores the address (in RPU Data Memory) of the next Cell in the chain. Software initializes this list at the start of time to allocate all Cells to the Free List. The size of this space should be 512K*18.

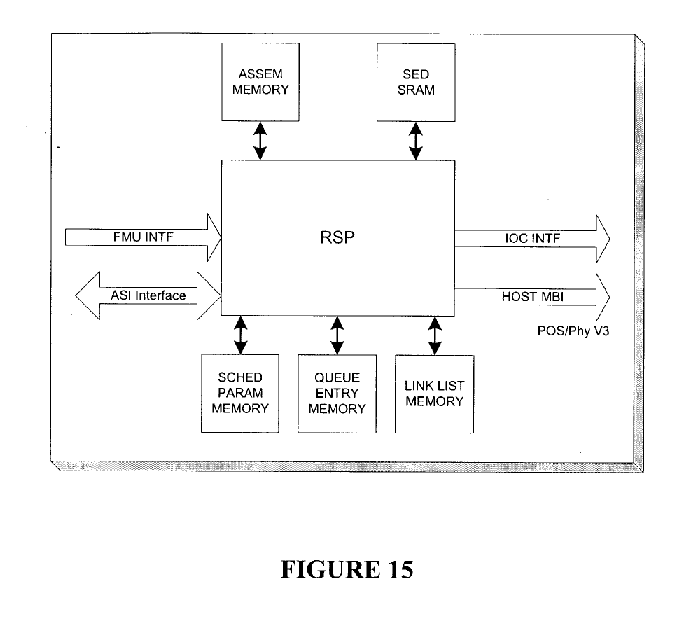

Routing Switch Processor (RSP)—FIG. 15

This section will explain the Agere Routing Switch Processor (RSP). It is not the intent of this section to reproduce the RSP specifications, however the functional use of the part is explained here. Also listed are the memories and connected interfaces.

The RSP is a complex part from Agere Inc, which is responsible for egress header manipulation, egress traffic shaping, egress multicasting and traffic management. The RSP and its associated memories and interfaces are shown in FIG. 15.

RSP Functionality

Egress Traffic Management

When a complete PDU is received from a context, the DID from the Transmit Command is looked up in the DID table. The DID table returns a QID number which is looked up in the QID table. The parameters from the QID table, and the DID table are passed on to the Traffic Management Compute Engine. A list is compiled below.

16 bytes of per queue data

PDU length

Queue memory utilization

8-bit random number

The traffic management compute engine will return the following values after executing one of RED, WRED, EPD, PPD etc. These algorithms are software/microcode based and therefore can be enhanced.

8 bytes of modified parameters

accept/discard flag

When the PDU is accepted it is placed on the Queue ID associated with the PDU in the DID table. If queue was previously empty, then it is also added to the scheduler table.

Egress Header Manipulation

The DID table entry has a parameter list pointer and a Script Editor pointer. Scripts are stored within the RSP and the Script Parameters are stored on board. Once the PDU is being transmitted, the table Script begins to execute on the PDU data and the parameters fetched from the DID memory at the parameter offset. Up to 63 bytes of data can be appended to the datagram and up to 16 bytes can be appended to the end of a PDU.

RSP Interfaces

This section will list the interfaces on the RSP.

RPU -> RSP Interface

The RPU Interface is a modified POS-PHY interface (32 b@100 MHz), wherein the RPU device acts as the Receive slave with the RSP acting as Receive master. The port number (Multi-PHY address) represents the context ID of the data. Following each PDU transferred from the RPU, a Transmit Command arrives in-band with the port number equal to the arriving PDU's port number plus 128.

IOC Interface

This interface is the POS-PHY or UTOPIA interface provided by the RSP to the IOC, with an aggregate rate of 32 bits@100 MHz. User data is sent from this interface directly to the IOC. The IOC interface is symmetric—that is, it is the same configuration for both transmit and receive dataflow.

Management Output Interface

The Management Output Interface is strictly for sending data to the Host processor. This is a POS-PHY interface with no multi-PHY support. This is an 8 bit wide interface with clock rates up to 133 MHz.

RPU Backpressure Interface

The RSP has two bits that are sent back to the RPU, indicating two levels of backpressure. The first backpressure bit indicates to the RPU to not start any PDUs on a fresh context, i.e. finish all current PDU streams. The second backpressure bit indicates to stop all blocks.

IOC Backpressure Interface

If an IOC requires backpressure to the RSP (for example, an Ethernet transmit FIFO is near to overflowing), then the IOC signals the RSP to stop sending data on that port. The current mechanism for performing this backpressure is via the UTOPIA or POS-PHY ready-polling protocol. One or more PHY devices may signal “not ready” to inform the RSP that buffers are not available. This backpressure will cause the RSP to stop traffic on a single logical port.

ASI Interface

This is an interface that communicates with the ASI, which in turn communicates with the Host Processor. All RSP setup and configuration is done via this interface.

RSP Memories

The RSP has five memories, each explained in this section.

RSP Assembly SDRAM

Data from the RPU is received via the RPU Interface and stored in Assembly SDRAM. Data arrives on one of 64 possible context IDs, which are reordered and assembled in Assembly SDRAM. In our case there should be no reordering required since the RPU does not do context switching. Data stored in the Assembly memory is primarily for shaping purposes. Host processor is not expected to access this memory, except during diagnostics.

RSP SED SRAM

The Stream Editor (SED) SRAM stores per DID information. For each DID, the following pieces of information are stored.

Script Number: This is an 11-bit number that selects a particular script for datagrams on the corresponding DID.

Parameter: This is a 21-bit number that indicates a offset in the SED memory where parameters for the script are stored. These parameters are unique information for the particular flow. There is also a field that tells the length of the parameters.

Last DID: This bit indicates the last of a multicast group of DID entries.

Header Manipulation size: There are three fields that dictate the size of header padded at the start or end of datagram.

Transmit QID: This 16-bit entry represents the Queue the datagram is placed on. There are 64K such Queues in the RSP system.

Besides the DID tables, SED memory also stores the parameters needed by the SED. The size of this memory is based strictly on the number of connections and the parameters per connection.

RSP Scheduler Parameter SRAM

Scheduler Parameter Memory contains the parameter storage for the compute engines that allows state to be associated with each queue. This SRAM also holds the scheduler time slot lists for use with time based scheduled traffic. Each compute engine has 16 bytes of parameters that allow it to maintain state based upon each queue. Therefore for 64K queues we need 1 MB of memory. This memory is 32 bits wide.

RSP Queue Entry SRAM

The Queue Entry SRAM holds all of the queue entry parameters that are used to maintain the operation of each queue. Each queue occupies 16 bytes of SRAM. The Queue IDs have 16 bits of addressing which is capable of supporting 64K queues. To support all queues the external memory should be 1 Mbytes. This memory is also 32 bits wide.

RSP Linked List SRAM

Linked List Memory contains an SRAM Map that is used to virtually link SDRAM blocks together to form PDUs as well as link PDUs together in a queue. The Host processor is not expected to access this memory during real time, however it may be expected to initialize the free list at the start of time.

RSP Scheduler Configuration Table

This 1 K table contains the configuration for a schduler.

RSP Port Table

This is internal memory to the RSP. Each entry of this table has a Scheduler ID. It is assumed that multiple Scheduler IDs are associated with a particular physical port. These table entries are prioritized per port.

RSP Logical Port Table

This is internal memory to the RSP. Each entry controls the scheduler for a logical port. This table has 256 entries.

Described above are apparatus and method meeting the intended goals. It will be appreciated that the above embodiments are presented for illustrative purposes only. Those skilled in the art will appreciate that various modifications can be made to these embodiments without departing from the scope of the present invention.

Packet Disassembly, Routing and Reassembly

Various protocols (e.g., TCP/IP, UDP, ATM, Frame Relay) govern the format of data received for routing by a network device 10 of the type shown in FIG. 1 and discussed in detail above. For example, e-mail messages, files or other data received under the TCP protocol are divided into chunks, commonly referred to as packets, each of which includes Internet source and destination addresses, among other identifiers. The individual packets may travel different routes between their respective sources and destinations, some or all of them being received and rerouted by the network device 10 along the way. Data transmitted per the other protocols are similarly packetized (e.g., in units called datagrams, cells, or so forth) and may similarly be transmitted along disparate routes before reaching the network device 10 and/or their respective final destinations.

Regardless of the particular form and route the packets, datagrams, cells or other chunks (hereinafter, collectively “packets” or “PDUs”) take, once they enter a node constructed and operated in the manner of network device 10 the packets are further disassembled (or formatted) for routing through the device and, subsequently, reassembled (or reformatted) into packets for continued routing to their destinations, all as discussed above. The text that follows reviews the mechanisms for these purposes, achieving fast device throughput, while meeting service level agreement constraints.

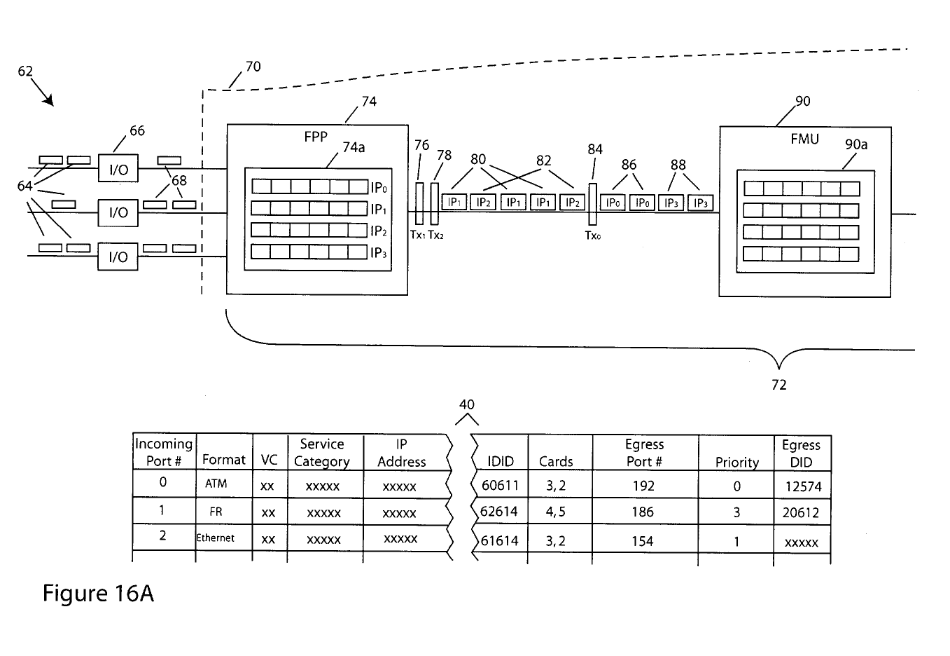

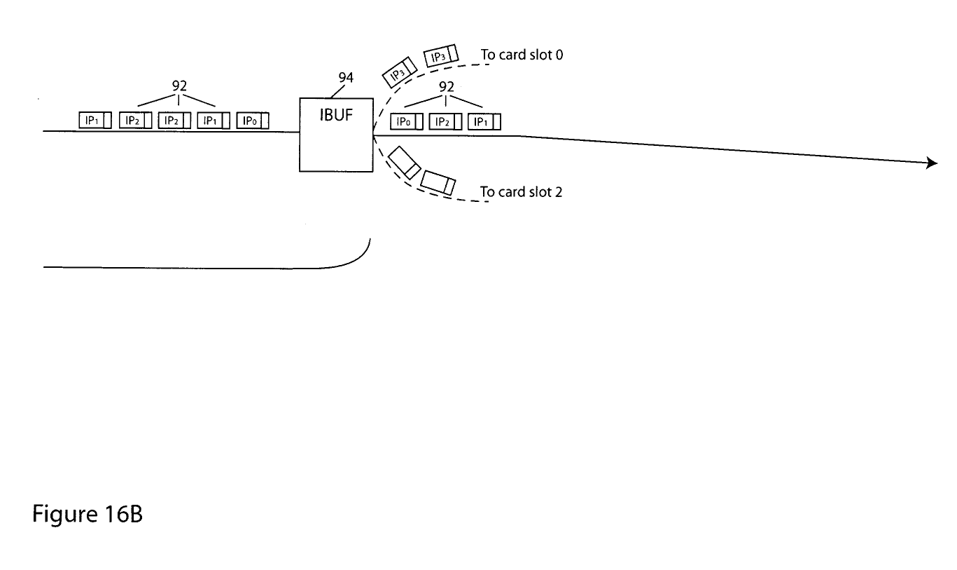

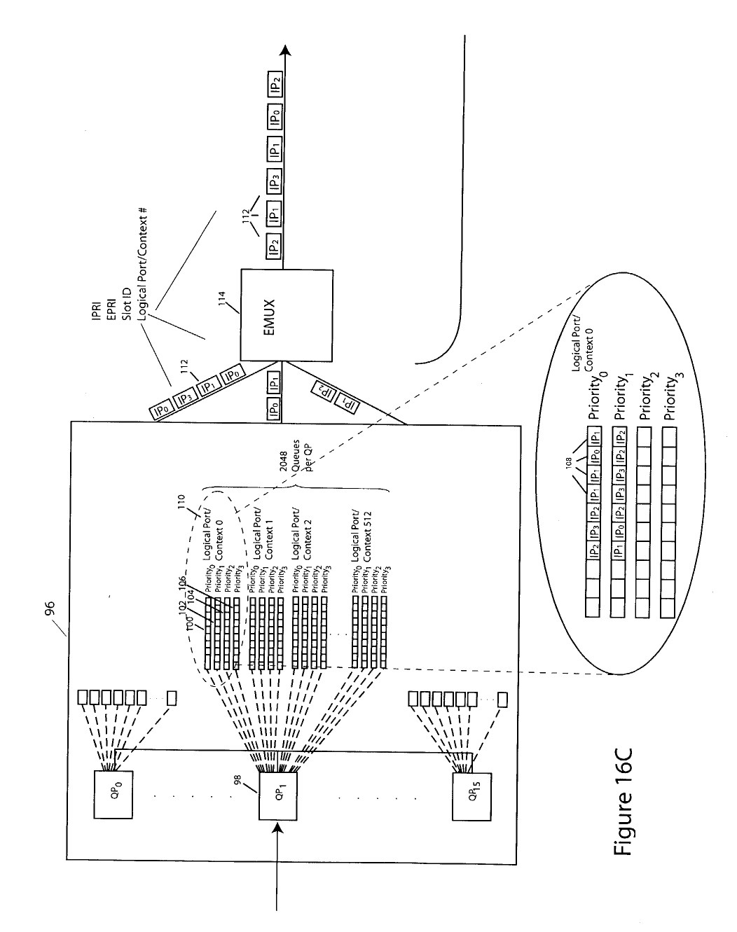

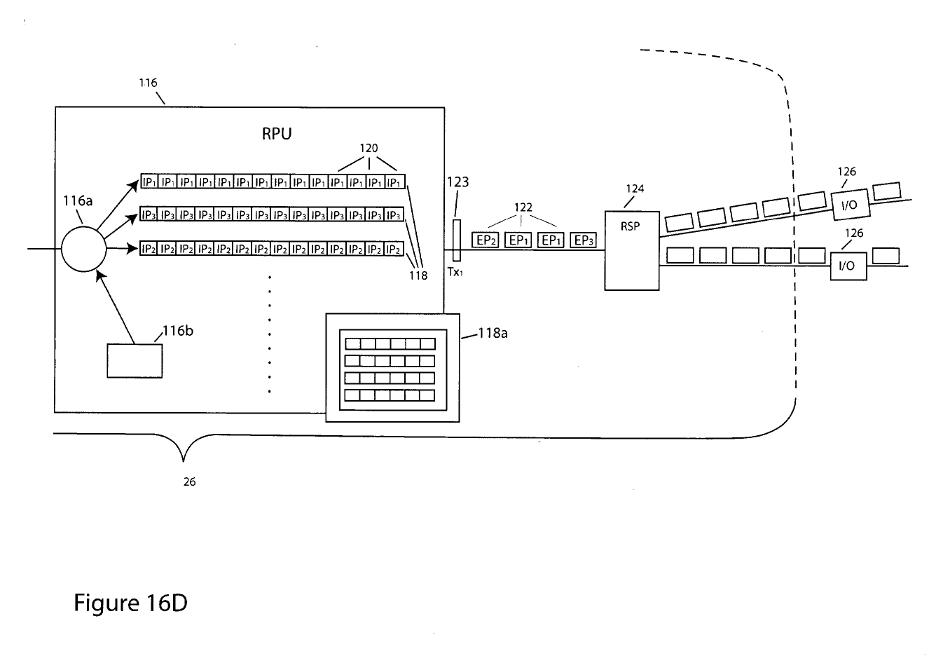

By way of overview, the output interface 26 utilizes a reassembly element, particularly, RPU 26a, that reassembles packets based on designators added to their disassembled constituents (referred to below as GCells) by the input section. This can include the context designator, as well as priority designators and a slot designator. The network device 10 also utilizes a novel two-part priority indicator—with one part (referred to as IPRI) determining priority through the network device's input section 18 and the second part (referred to as EPRI) determining priority through a switching and output sections to rapidly maximize a network router's throughput capability. FIGS. 16A-16D illustrate these and other aspects of the illustrated system.

As discussed above, incoming network traffic 64 comprised TCP/IP, ATM, frame relay, or other “packets” 64 originating from one or more network connections, enter the device 10 through one or more I/O cards 66. The I/O cards 66 route the various packets 64 to the corresponding input interface 72 on the associated card 70. Those skilled in the art will appreciate that packets 68 typically arrive at the input interface 72 as intermingled streams, with packets of one stream intermingled with packets of one or more other streams.

Illustrated input interface 72 is comprised of I/O transceivers 66 and the three modules discussed above, the FPP 74, FMU 90, and the IBUF 94, though that of other embodiments may utilize greater or fewer modules of the same or varying functionality. By way of overview, the incoming packets 68 are fragmented and sequentially processed (e.g., for inclusion of priority and routing information) by these three modules and then transferred to the appropriate queue processor 98 residing in a switching mechanism 96 on a particular card 70. From there, the fragmented packets (GCells) are routed to an appropriate output section 26 for reassembly and, finally, retransmission onto the network.

As discussed above, the FPP 74 utilizes a two-pass processing scheme to parse headers as the data moves from the I/O cards into memory, and then onto the FMU 90. The FPP 74 initially aggregates and assembles the incoming packets 68 into their respective PDUs or protocol data units, e.g., ATM, IP. It can also assemble them into such another format as is specified in the configuration table 40, e.g., reassembling frame relay to ATM. The protocol data units are stored in one of 64K linked-list queues. These queues are then linked onto one of four priority queues 74a.

The first pass processing yields the ingress-priority that corresponds to one of the four priority classification queues 74a that a particular protocol data unit belongs on. The FPP 74 links the protocol data units to any one of the four priority queues 74a based on the ingress priority that is derived during the first pass processing. The ingress priority determines the priority with which the packet is processed in the input section 72, particularly, as discussed in connection with processing by the FMU 90 below. The ingress priority will later be utilized by the RPU 116 to reassemble the packets.

During the second pass processing, the FPP 74 utilizes the ingress priority as well as the destination IP address, input port and format of the incoming packet 68 to determine the ingress destination identifier or IDID. As discussed below, this is utilized by the FMU 90 to determine routing information for a corresponding packet).

The FPP 74 then segments the protocol data units into 64 byte chunks, dequeues the chunks based on ingress priority, and transfers the chunks 80, 82, 86, 88 to the FMU 90 for further processing. The transfer of chunks may be interleaved with chunks of other protocol data units. The interleaving is due to the variability of packet size, and because the FPP 74 dequeues the protocol data units based on ingress priority. When a particular chunk stream comprising a protocol data unit is completely dequeued, the FPP 74 appends a corresponding transmit bit 76, 78, 84 to the chunk stream to denote the end of the transfer. The transmit bits 76, 78, 84 indicate the ingress priority, IDID, and other classification results (e.g., length, offset, discarded bits) of the associated protocol data units, which are comprised of chunk streams 80, 82, and 86 respectively.

The FMU 90 receives and reassembles the incoming chunks 80, 82, 86, 88 into complete protocol data units, and queues the protocol data units based on arrival time and priority into any one of four priority queues 90a. Protocol data units that contain errors flagged by the FPP are dropped. The FMU 90 utilizes the IDID as an index value to look-up packet forwarding information in the configuration table 40. The IDID binds the egress port in the system to the processed protocol data unit. As shown in the configuration table 40, the forwarding information can include card number/slot, egress port number (context), egress priority, egress ID, etc. The FMU 90 utilizes the information in the configuration table 40 to establish the exact routing path through the system 62 for each respective packet.

Based on the configuration table 40 information, the FMU 90 segments and maps the reassembled protocol data units into 64 byte units (GCells) 92 that comprise 52 bytes of data and a 12 byte header. The FMU 90 loads each header with information comprising a drop priority, bit interleave parity indicator, DID, context, ingress priority, egress priority, sequence number, start of packet indicator, and end of packet indicator. The FMU 90 then forwards the units (GCells) 92 one at a time to the appropriate queue processor (QP) 98 residing in a switching mechanism 96 on a particular card via the IBUF 94 as indicated in the configuration table 40. Since the units 92 are dequeued from the four priority queues 90a, at any given time the FMU 90 may be forwarding up to four different packets to a corresponding queue processor 98 one unit 92 at a time resulting in intermingled units 92. At this point the units 92 may be intermingled only by their ingress priority. The IBUF 94 transfers the units 92 across the fully-meshed switch fabric (FIG. 1, item 20) to the predetermined slot\QP 98 residing in a switching mechanism 96 on a particular card.

Those skilled in the art will, of course, appreciate that practice of the invention is not limited to embodiments in which incoming packets are segmented into 64-byte chunks (as performed by the FPP) nor into GCells (as performed by the FMU) but rather, can be applied wherever incoming packets are disassembled for passage through a routing mechanism 96. Moreover, it will be appreciated that the invention is not limited to embodiment in which the disassembled packets are routed through queue processors of the type illustrated here but, rather, can be used with any mechanism, switching or otherwise, that moves the disassembled packets from in input section to an output section.

As discussed above, each queue processor has four priority queues associated with each of 512 output contexts (2048 queues per QP). The four priority queues are based on egress priority that corresponds to priority values in the configuration table 40. The QPs receive and store units destined for a particular context in the appropriate egress priority queue as contiguous units based on the unit's corresponding header values.

Specifically, the QP 98 receives the incoming units 92 and examines each unit's header to determine the context, and the egress priority level that pertain to that particular unit. The QP 98 then loads each unit into the appropriate priority queue 100, 102, 104, 106 for a particular context 110. Although a priority queue 100 contains units having the same egress priority and destined for the same context 110, the units 108 themselves may be intermingled based on ingress priority, if received that way from the four priority queues 90a in the FMU 90.

As discussed above, the QPs in coordination with the global scheduler dequeue queues based on priority, starve status, and by context. This results in units 108 being dequeued out of sequence, and further intermingled. Therefore, when QP 98 dequeues its priority queues, the resulting stream of units 112 that is forwarded to the output interface 26 may be intermingled based on ingress priority, egress priority, context, and slot number.

The output interface 26 is comprised of the I/O transceivers 126, an EMUX 114, RPU 116, and a RSP 124. The EMUX 114 funnels (16 to 1) and forwards the intermingled units 112 to the RPU 116, i.e., in the manner of a multiplexer.

The RPU 116, which is discussed above, further comprises a demultiplexer 116a that strips off each unit's header and utilizes each unit's ingress priority, egress priority, context, and slot number to delineate and reassemble the intermingled units into their respective protocol data units. The protocol data units are stored in any of 128K linked list queues 118.

As the queues 118 are being filled, the RPU 116 utilizes an error module 116b to conduct error checking of the incoming increments, e.g., sequence errors, SOP, MOP, EOP, BIP, and timeouts (frames that don't finish). The RPU 116 drops packets that have errors. For example, if the error module 116b detects a sequence error, due to a missing GCell, then the entire packet will be dropped. As another example, if the last GCell (that contains the EOP indicator) of a particular protocol data unit fails to arrive at the RPU 116 within a predetermined time threshold, the entire packet would be dropped to prevent the RPU from idling in wait for the EOP.

If no errors are detected, then when the RPU 116 receives a unit with the EOP set, the corresponding protocol data unit is queued on one of the four egress priority queues 118a for output to the RSP 124. This mechanism implies that protocol data units are forwarded based on the arrival time of the EOP. The RPU 116 segments each reassembled protocol data unit into 64 byte increments and forwards the increments 122 to the RSP 124 based on priority. The RPU 116 also appends a transmit bit 123, which contains the egress identifier (EDID), to the end of each stream 122. It should be appreciated that the RPU 116 output 122 mirrors that of the FPP 74.

The RSP 124 receives and reassembles the increments 122 in linked list queues. When the transmit bit 123 is received, the RSP 124 utilizes the egress identifier (EDID) to queue the increments 122 based on egress priority, and to transfer the packets to the appropriate I/O cards 126 for transmittal to the respective destination network connections.

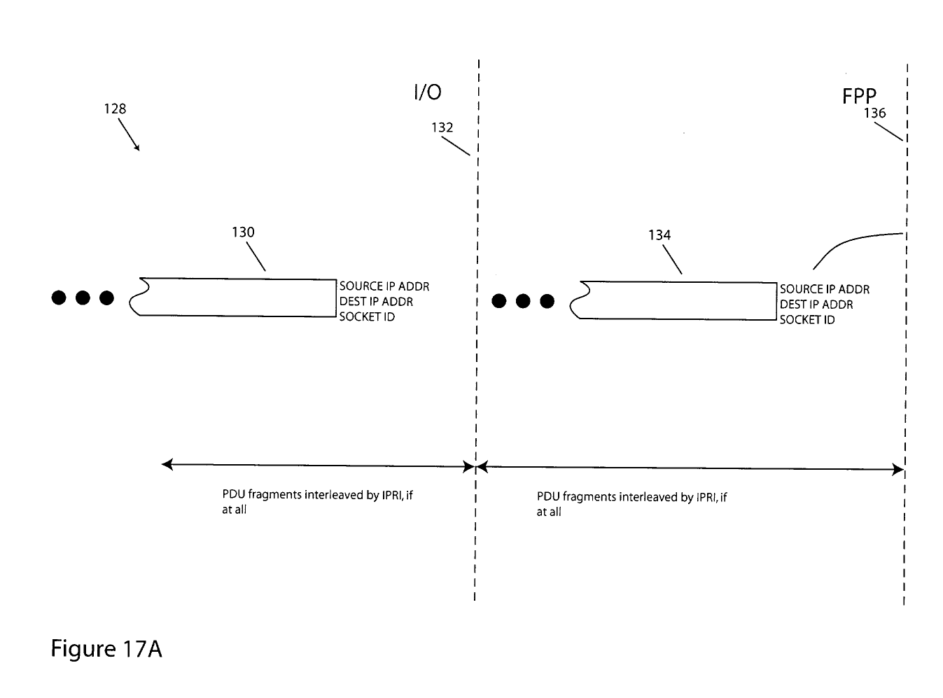

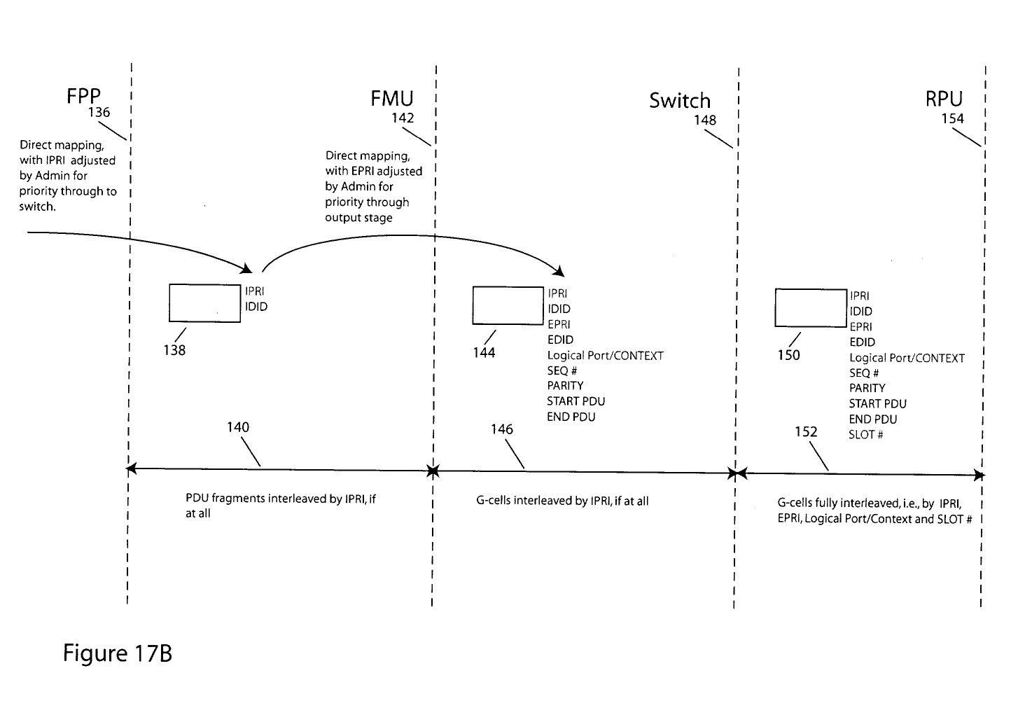

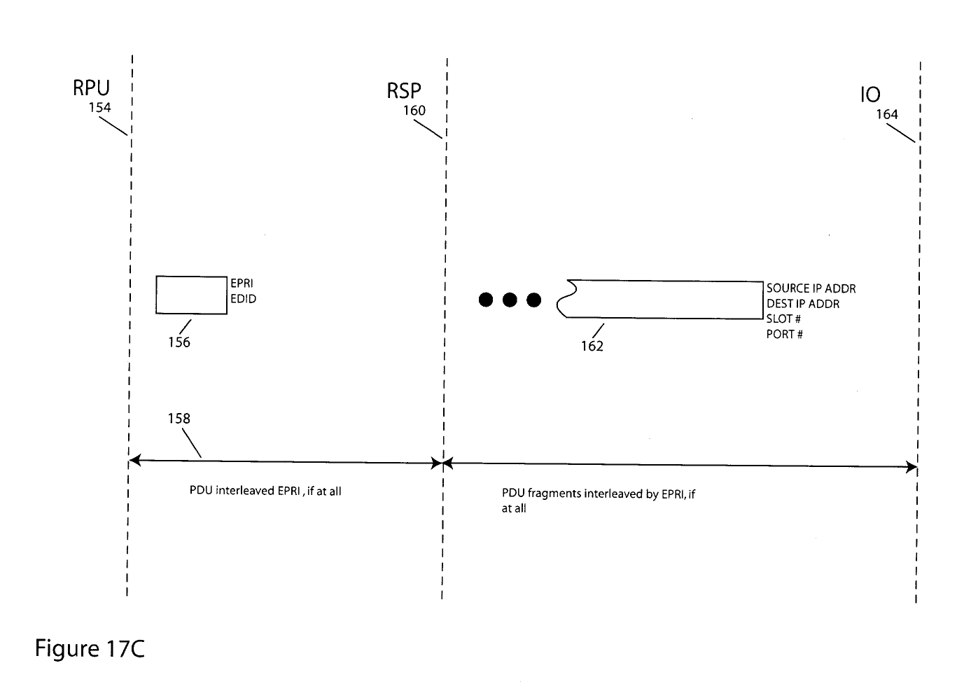

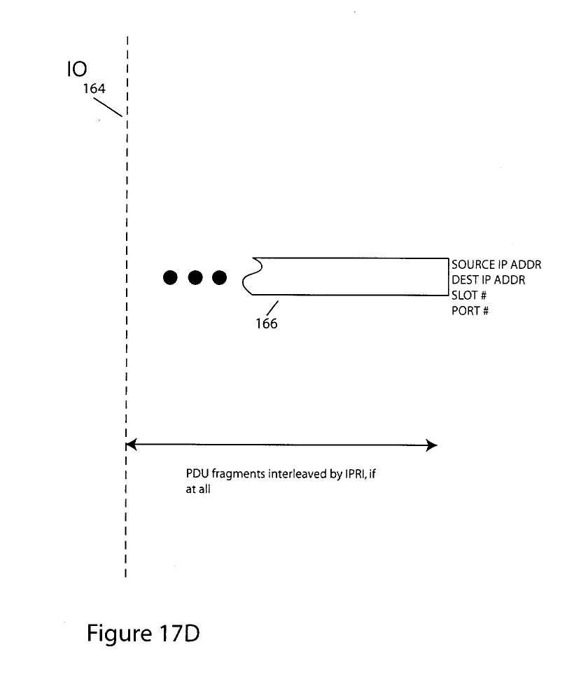

FIGS. 17A-17C illustrate the degree to which protocol data unit fragments are interleaved at each stage through the system. Initially, an incoming packet 130 enters the system through I/O card 132. At this point, packets (marked by source IP address, destination IP address, and socket ID) of one stream are interleaved with packets of other streams (which are similarly marked with their own respective source IP address, destination IP address, and socket ID).

As detailed above, the FPP 136 associates the incoming packet 130 with an ingress priority and IDID. The packet 130 is then fragmented into 64 byte chunks 138 that are transferred to the FMU 142. Chunks 138 enroute to the FMU 142 are interleaved only by ingress priority, if at all.

As also detailed above, FMU 142 receives and reassembles the incoming chunks 138 into GCells 144 that are then transferred to the switch mechanism 148. The FMU 142 loads the GCell headers with a variety of forwarding information, including drop priority, bit interleave parity, datagram identifier, context, IPRI, EPRI, sequence number, start of packet, and end of packet, which will be used by the RPU for reassembly. GCells 144 generated by the FMU and enroute to the switch mechanism 148 are interleaved only by ingress priority, if at all.

The switch mechanism 148 receives the incoming GCells 144, routes them as described above, and transfers them to the RPU 154. As a result of the operation of the queue processors, as detailed above, GCells 150 enroute to the RPU 154 are interleaved, i.e., by ingress priority, egress priority, context, and slot number.

The RPU 154 receives the incoming GCells 150 and utilizes the ingress priority, egress priority, context, and slot number to delineate and reassemble the GCells 150 into protocol data units. Each protocol data unit is then segmented into increments 156 that are transferred to the RSP 160. When passing from the RPU 154 to the RSP 160, the segments 156 are only interleaved by egress priority, if at all.

The RSP 160 receives the increments 156 and reassembles the original packets 162 that are then transferred to the I/O card 164 for forwarding to output network connections.

The above embodiments are presented for illustrative purposes only. Those skilled in the art will appreciate that various modifications can be made to these embodiments without departing from the scope of the present invention. Thus, for example, it will be appreciated that disassembled packets routed through the illustrated device may be interleaved at greater or fewer levels than so in the illustrated embodiment.

In view of the foregoing, what is claimed is:

1. A network device, comprising:
a plurality of input interfaces, each receiving data from one or more respective network connections,
an output interface for transmitting data to one or more respective network connections, each of which is associated with a plurality of network contexts.
a plurality of queue processors, each coupled to a respective input interface and to the output interface, each queue processor transferring selected data received from the respective input interface to the output interface,
the plurality of queue processors so transferring the data as to maintain quality of service levels with respect to throughput of data from the plurality of input interfaces to the output interface.

2. The network device of claim 1, wherein the queue processors perform any one of receiving data, queuing data, dequeing data, discarding data, and maintaining data statistics.

3. The network device of 1, wherein each queue processor comprises a plurality of queues, each storing data for a selected network context.

4. The network device of claim 3, wherein the queue processors dequeue data based on parameters defined as a function of network context.

5. The network device of claim 3, further comprising a scheduler coupled to the queue processors that schedules dequeing of data from their respective queues for transfer to the output interface.

6. The network device of claim 5, wherein the scheduler polls each queue processor to determine its respective status in relation to the queuing of data for selected network contexts.

7. A network device, comprising:
a plurality of input interfaces, each receiving data from one or more respective network connections,
an output interface for transmitting data to one or more respective network connections, each of which is associated with a plurality of network contexts.
a plurality of queue processors, each coupled to a respective input interface and to the output interface, each queue processor transferring selected data received from the respective input interface to the output interface,
a scheduling table having a plurality of entries that define an order for potential transfer of data to the output interface,
the plurality of queue processors transferring the data as a function of network contexts identified in the scheduling table.

8. The network device of claim 7, wherein
each queue processor comprises a plurality of queues, each storing data for a selected network context, the device further comprising
a scheduler coupled to the queue processors and to the scheduling table, the scheduler polling the queue processors to determine their respective statuses in relation to data queued for selected network contexts identified in the scheduling table.

9. The network device of claim 8, wherein the scheduler schedules transfer of data from the queues to the output interface as a function of network contexts identified in the scheduling table and as a function of the respective statuses of the queue processors in relation to data queued for selected network contexts.

10. The network device of claim 9, wherein dequeing of data is based on a response received from the queue processors regarding their status.

11. In a network device the improvement comprising,
a plurality of queue processors, each coupled to a respective input interface and associated with one or more queues that store data, each queue processor:
receiving data from the respective interface, storing the data into a queue associated with that queue processor, and
dequeing the data per context by priority from a selected queue, and transmitting the data to an output interface that is coupled to the plurality of queue processors for transferring data therefrom to one or more network connections.

12. The network device of claim 11, wherein the queue processors additionally perform any one of discarding the data, and maintaining a list of statistics and parameters in memory.

13. The network device of claim 11, wherein the data is stored in linked-list queue structures.

14. The network device of claim 13, wherein each queue processor is associated with a plurality of queues storing data, each queue having a different priority level, and each respective plurality corresponding to a network connection that data is transferred to from the queues.

15. The network device of claim 14, wherein the priority level has any one of four values.

16. The network device of claim 1, wherein a queue is selected for dequeing by a scheduler that is coupled to and interfaces with one or more queue processors to identify a queue processor requiring service and a particular priority queue associated with that queue processor that corresponds to a network context.

17. The network device of claim 16, wherein the scheduler polls each queue processor to determine their respective status in relation to a corresponding network context.

18. The network device of claim 17, wherein the queue processors that have data for a corresponding network context, respond to the scheduler by indicating the priority of the data and whether any given queue has not been serviced within a certain time threshold.

19. The network device of claim 16, wherein the scheduler schedules dequeing of data by selecting a specific queue processor and corresponding priority queue to dequeue.

20. The network device of claim 19, wherein the dequeing of data is performed according to the priority of the data in a particular queue.

21. The network device of claim 20, wherein the scheduler selects a specific queue processor and corresponding priority queue for dequeing by evaluating which queues have priority to send and which queues have not been serviced within a certain time threshold.

22. The network device of claim 21, wherein the queues that have not been serviced within a certain time threshold are starved queues.

23. In a network device, the improvement comprising,
a plurality of queues that store data,
one or more queue processors associated with a plurality of queues,
a scheduler coupled to the queue processors that schedules dequeing of data from one or more queues based on priority.

24. The network device of claim 23, wherein a queue is selected for dequeing by a scheduler that is coupled to and interfaces with one or more queue processors to identify, a queue processor requiring service and a particular priority queue associated with that queue processor that corresponds to a network context.

25. The network device of claim 24, wherein the scheduler polls each queue processor to determine their respective status in relation to a corresponding network context.

26. The network device of claim 25, wherein the queue processors that have data for a corresponding network context, respond to the scheduler by indicating the priority of the data, and whether any given queue has not been serviced within a certain time threshold.

27. In a network device, the improvement comprising,
a plurality of queues that store data being transferred between one or more input interfaces of the network device to one or more output interface of the network device,
a scheduler that schedules dequeing of data from the queues for transfer to the one or more output interfaces, the scheduler normally scheduling dequeing to proceed in a predetermined order,
a starve indicator associated with each of one or more queues, the starve indicator representing whether the associated queue has been dequeued within a certain time threshold,
the scheduler responding to the starved indicator by scheduling dequeing of the associated queues out of sequence.

28. The system of claim 27, wherein the scheduler schedules a queue associated with the starve indicator for dequeing before a queue that is not associated with the starve indicator.

29. The system of claim 28, wherein
the starve indicator has an initial numerical value, and
wherein a queue processor modifies that value each time the scheduler does not select the queue associated with that indicator for dequeing.

30. The system of claim 29, wherein
the starve indicator has an initial positive numerical value, and
wherein a queue processor decrements that value each time the scheduler does not select the queue associated with that indicator for dequeing.

31. The system of claim 30, wherein the queue processor increments the starve indicator into a positive numeric range when the associated queue is scheduled for dequeing.

32. In a network device the improvement comprising,
a plurality of queues that store data,
a scheduler that schedules dequeing of data from one or more queues,
an aggregation mask associated with one or more queues, the aggregation mask indicating that dequeing of data from queues is only permitted for queues that have not been dequeued within a certain time threshold,
the scheduler responding to the aggregation mask by scheduling dequeing of only associated queues.

33. The system of claim 32, comprising a starve indicator associated with each of one or more queues that have not been dequeued within a certain time threshold.

34. The network device of claim 33, the starve indicator has an initial numerical value, and wherein logic modifies that value each time the associated queue is polled but not selected for dequeuing.

35. The network device of claim 34, wherein the logic resets the value of the starve indicator each time the associate queue is dequeued.

36. In a network device the improvement comprising,
a plurality of queues that store data being transferred between one or more input interfaces of the network device to one or more output interface of the network device,
one or more queue processors associated with a plurality of queues, each queue processor selectively dequeing data from one or more associated queues and selectively generating a status signal indicating the status of the associated queues,
a scheduler that polls the queue processors for the status of their associated queues and that signals a selected queue processor to dequeue data from an associated queue,
a master indicator associated with a selected queue processor,
the selected queue processor generating a status signal on behalf of one or more other queue processors in response to polling by the scheduler,
the scheduler signaling a queue processor to dequeue data based on a response of the selected queue processor.

37. A network device, comprising:
a plurality of input interfaces, each receiving data from one or more respective network connections,
an output interface for transmitting data to one or more respective network connections.
a plurality of queue processors, each coupled to a respective input interface and to the output interface, each queue processor transferring selected data received from the respective input interface to the output interface,
the plurality of queue processors so transferring the data as to maintain quality of service levels with respect to throughput of data from the plurality of input interfaces to the output interface,
a scheduler coupled to the queue processors that schedules dequeing of data from their respective queues for transfer to the output interface,
the scheduler signaling a queue processor for dequeing of data based on at least one of a priority of that data and a time period since data was last dequeued from a respective queue associated with a particular queue processor.

38. The network device of claim 37, further comprising
a scheduling table having a plurality of entries, wherein each entry storing at least one of
a context number identifying a particular output network connection to which data is to be transferred in sequence,
an aggregation mask associated with one or more context numbers and indicating that dequeing is only queues that have not been serviced within a certain time threshold,
master indicator indicates that signaling to the scheduler from the queue processors is to be taken from one queue processor only, which serves as a collecting point for at least certain responses of all the queue processors for a given context number,
the scheduler signaling a queue processor for dequeing of data by context number based on the aggregation mask value and master indicator value.

39. The network device of claim 38, wherein the scheduling table lists context numbers in an order and frequency that insures quality of service for each destination network.

40. The network device of claim 38, wherein the scheduler selects a context number from the scheduling table and polls one or more queue processors to determine if the queue processors are ready to transfer data for that context number, to the corresponding network connections.

41. The network device of claim 40, wherein the scheduler selects an entry from the scheduling table at predetermined intervals to determine a context number to be serviced

42. The network device of claim 40, wherein the queue processors that have data for a corresponding context number, respond to the scheduler by signaling the priority of the data for that context number, and whether any given queue has not been serviced in a predetermined period.

43. The network device of claim 42, wherein the priority level can be any one of four possible levels.

44. The network device of claim 43, wherein the indicator showing priority level is a ready state.

45. The network device of claim 51, wherein the scheduler selects queues that have not been serviced for the predetermined period before servicing all other queues regardless of priority.

46. A network device, comprising:
an input section receiving any of cells, frames, datagrams, or other packets (collectively, “packets”) from one or more respective network connections, and fragmenting at least selected received packets into one or more respective units,
an output section transmitting packets to one or more respective network connections, each of which is associated with a plurality of network contexts,
a routing mechanism, coupled to the input section and to the output section, the routing mechanism transferring units from the input section to the output section,
the output section including a reassembly unit that reassembles into respective packets a plurality of intermingled units received by the output section from the routing mechanism, the reassembly unit reassembling the units on the basis of at least the context associated with the network connection to which the respective packets are directed.

47. The network device of claim 46, wherein the input section assigns an ingress priority to each received packet, and transfers the units to the routing mechanism intermingled, if at all, on at least the basis of the ingress priority.

48. The network device according to claim 47, wherein the input section utilizes the ingress priority to associate each corresponding packet with an identifier that is utilized to determine one or more routing path parameters for each unit, including an egress priority that pertains to a priority level associated with a queue in the routing mechanism that the unit is destined for.

49. The network device according to claim 47, wherein the reassembly unit reassembles the intermingled units into their respective packets based on the context and priority of the respective units.

50. The network device of claim 48, wherein the routing mechanism transfers units to the output section intermingled on at least the basis of context, slot number, ingress priority, and egress priority.

51. The network device according to claim 50, wherein the reassembly unit reassembles the intermingled units into their respective packets based on the context, slot number, ingress priority, and egress priority of the respective units.

52. The network device according to claim 50, wherein the output section checks the received units for errors and timeouts, reassembles the intermingled units into their respective packets, discards packets having errors, and forwarding the packets to their respective destination network connections based on priority.

53. In a network router, the improvement comprising:
one or more output interfaces receiving intermingled portions of different respective packets,
the one or more output interfaces including a reassembly unit that reassembles the portions into their respective packets in accord with at least the context associated with the network connection to which the respective packets are directed.

54. The network router of claim 53, wherein the one or more output interfaces include a transfers packets received from the reassembly unit to corresponding network connections based on egress priority.

55. The network router of claim 53, wherein the reassembly unit reassembles the units based on all or any one of a context, priority, and slot number.

56. The network router of claim 55, wherein the priority comprises at least one ingress priority, and at least one egress priority.

57. A network device, comprising:
one or more input interfaces, each receiving any of cells, frames, datagrams, or other packets (collectively, “packets”) from one or more respective network connections, and fragmenting at least selected received packets into one or more respective units,
one or more routing mechanisms, coupled to the one or more input interfaces and to one or more output interfaces, that transfer units from the one or more input interfaces to the one or more output interfaces,
the one or more output interfaces transmitting packets to one or more respective network connections, each of which is associated with a plurality of network contexts,
the one or more output interfaces receiving intermingled units of different respective packets and reassembling those units into their respective packets in accord with at least the context associated with the network connection to which the respective packets are directed,
the input interface including an aggregation module that (i) associates each received packet with an ingress priority and identifier and that (ii) fragments each packet into one or more respective fragments, and (iii) forwards each fragment to a standardizer.

58. The network device of claim 57, wherein the standardizer module utilizes the identifier associated with each fragment to determine routing thereof, reassembles the fragments into packets, segments the packets into one or more units for transfer to the one or more routing mechanisms.

59. The network device of claim 58, wherein the standardizer module associates each unit with at least one of a context, output slot number, and egress priority.

60. The network device of claim 57, wherein the one or more routing mechanisms receive intermingled units, each having a respective ingress priority and egress priority, store the units into one or more queues in accord with egress priority, and transmit the units to the one or more output interfaces in accord with the egress priority level.

61. The network device of claim 60, wherein the reassembly unit reassembles the units into their respective packets in accord with (i) a context associated with the network connection to which the respective packets are directed, (ii) an ingress priority and (iii) an egress priority.

62. A network device, comprising:
an input interface that receives any of cells, frames, datagrams, or other packets (collectively, “packets”) from one or more respective network connections and that fragments at least selected received packets into one or more respective units,
a routing mechanism, coupled to the input interface and to an output interface, that transfers the units from the input interface to the output interface,
the output interface receiving units of different respective packets that are intermingled with one another and reassembles the units into their respective packets in accord with at least the context associated with the network connection to which the packets are directed,
wherein the routing mechanism includes a plurality of queues, each storing the received units for a selected network context, the queues being associated with one or more digital data processors that transfer units received from the respective input interface to the output interface based on a priority scheme.

63. The network device of claim 62, wherein the digital data processors dequeue units as a function of priority and context.

64. The network device of claim 62, wherein the routing mechanism stores the intermingled units each having a respective ingress and egress priority level into one or more queues that correspond to an egress priority level.

65. The network device of claim 64, wherein at least the egress priority level has any one of four values.

66. The network device of claim 62, wherein the reassembly unit reassembles the units into their respective packets in accord with at least the context associated with the network connection to which those units are directed, and with one or more priorities associated with the units.

67. The network device of claim 66, wherein the priorities comprise at least one ingress priority that pertains to the priority level associated routing of the unit through the input interface and at least one egress priority that pertains to the priority level associated with dequeuing of the unit within routing mechanism.

68. The network device of claim 66, wherein the reassembly unit reassembles the units into their respective packets by all or any combination of context, priority, and slot number.

69. The network device of claim 62, wherein the reassembly unit reassembles the units into one or more respective packets based on slot number, ingress priority, egress priority and context.
